(19) United States
(12) Patent Application Publication
(10) Pub. No.: US 2026/0291850 A1
(43) Pub. Date: Sep. 24, 2026

(54) SYSTEM

(71) Applicant: SoftBank Group Corp., Tokyo (JP)

(72) Inventor: Takayuki OZAKI, Tokyo (JP)

(73) Assignee: SoftBank Group Corp., Tokyo (JP)

(21) Appl. No.: 19/567,518

(22) Filed: Mar. 16, 2026

(30) Foreign Application Priority Data
Mar. 19, 2025 (JP) 2025-045087

(51) Int. Cl. H04L 45/02; G06N 3/045; H04L 51/02

(52) U.S. Cl. CPC H04L 45/08; G06N 3/045; H04L 51/02

(57) ABSTRACT

A system includes a processor that is configured to receive an input from a user and generate a first prompt for instructing a generative artificial intelligence model to identify a learning objective of the user, generate a second prompt for instructing the generative artificial intelligence model to analyze the input from the user, and input to the generative artificial intelligence model a third prompt for selecting, based on an analysis result obtained from the generative artificial intelligence model, an appropriate educational resource corresponding to the learning objective.

### CROSS-REFERENCE TO RELATED APPLICATION

This application is based on and claims priority under 35 USC 119 from Japanese Patent Application No. 2025-045087 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional self-learning platforms rely on manually designed rules or static recommendation engines to interpret user input, identify learning objectives, and select educational resources. In many cases, a user expresses learning needs in natural language, and the system must map these expressions to structured learning goals using predetermined keyword lists or rigid forms. Such approaches often fail to accurately capture nuanced or complex user intentions, and they are not easily adaptable to diverse domains or evolving content. Moreover, existing systems typically require significant manual effort to maintain and update rule sets for goal extraction, input analysis, resource mapping, and learning path adaptation.

Additionally, although generative artificial intelligence models have recently been used for content generation and question answering, they are not systematically utilized as controllable components within a self-learning platform. In particular, there is no standardized mechanism for generating and providing prompts that (i) instruct the generative artificial intelligence model to identify learning objectives, (ii) instruct the generative artificial intelligence model to analyze user input, and (iii) instruct the generative artificial intelligence model to select appropriate educational resources based on analysis results. As a consequence, the interaction between a self-learning platform and a generative artificial intelligence model tends to be ad hoc, non-repeatable, and difficult to integrate into a robust system architecture.

Furthermore, conventional systems do not provide a sufficiently structured way to leverage generative artificial intelligence models for monitoring user learning progress and dynamically updating learning paths. In many platforms, the update of a learning path is based on simple thresholds or static logic, without using the generative artificial intelligence model to reason about progress, difficulty, and next-step recommendations via explicit prompts. As a result, the personalization of learning paths is limited, and the system cannot fully exploit the capabilities of generative artificial intelligence models to refine recommendations over time.

Therefore, there is a need for a system that systematically uses a processor to generate prompts for a generative artificial intelligence model, in order to (i) identify learning objectives from user input, (ii) analyze the user input, (iii) select appropriate educational resources based on analysis results, and (iv) monitor learning progress and dynamically update learning paths. Such a system should provide a structured, extensible framework for integrating generative artificial intelligence models into self-learning platforms, thereby improving the accuracy of goal extraction, the quality of resource selection, and the adaptability of learning paths.

### SUMMARY

To solve the above-described problems, an embodiment provides a system comprising a processor, wherein the processor is configured to control interaction with a generative artificial intelligence model by generating and supplying a plurality of prompts for different functions within a self-learning platform.

According to one aspect, the processor receives an input from a user and generates a first prompt for instructing a generative artificial intelligence model to identify a learning objective of the user. The processor thereby utilizes the capability of the generative artificial intelligence model to interpret natural language and to convert the user's free-form input into one or more structured learning objectives. The processor then generates a second prompt for instructing the generative artificial intelligence model to analyze the input from the user in more detail, for example to extract relevant topics, prior knowledge indicators, or constraints such as available time or preferred learning style. Furthermore, the processor inputs to the generative artificial intelligence model a third prompt for selecting, based on an analysis result obtained from the generative artificial intelligence model, an appropriate educational resource corresponding to the learning objective. In this way, the system uses explicit prompts to control the model so that it not only interprets the user's intention but also assists in selecting suitable resources from available online courses, textbooks, or other educational materials.

According to another aspect, the processor is configured to monitor a learning progress of the user and generate a fourth prompt for dynamically updating a learning path of the user in accordance with the learning progress. For example, the processor can maintain progress data for each educational resource, such as completion percentage or assessment scores, and can generate a prompt that instructs the generative artificial intelligence model to propose next steps or revised sequences of resources based on the observed progress and difficulty level. By doing so, the system enables the generative artificial intelligence model to reason about progression and to recommend an updated learning path that is better aligned with the user's current state.

According to still another aspect, the processor is configured to generate a fifth prompt for extracting the learning objective from input data of the user. In some embodiments, the fifth prompt may be specialized for handling particular types of input, such as long-term learning plans, updated preferences, or additional constraints. By separating the prompt for initial goal extraction from other prompts used for input analysis or resource selection, the system can modularize the interaction with the generative artificial intelligence model and can flexibly adapt or refine each prompt independently.

Through these configurations, the processor systematically generates and manages prompts that instruct the generative artificial intelligence model to perform distinct roles: identification of learning objectives, detailed analysis of user input, selection of educational resources based on analysis results, and dynamic updating of learning paths according to monitored progress. As a result, the system can more accurately understand user needs, flexibly adapt learning recommendations, and effectively integrate the capabilities of generative artificial intelligence models into a self-learning platform.

The term “system” refers to an arrangement of hardware and software components including at least one processor configured to perform specified functions for interacting with a generative artificial intelligence model in a self-learning environment.

The term “processor” refers to one or more hardware processing units, such as a central processing unit (CPU), a graphics processing unit (GPU), or a specialized accelerator, capable of executing instructions to perform the operations described in the claims.

The term “input from a user” refers to information provided by a user to the system, including but not limited to natural language text, selections made through a graphical user interface, or other data indicating the user's intentions, preferences, or learning context.

The term “prompt” refers to data generated by the processor and supplied as an instruction or query to a generative artificial intelligence model, the data specifying a task or request such as identifying a learning objective, analyzing user input, or selecting an educational resource.

The term “first prompt” refers to a prompt generated by the processor for instructing a generative artificial intelligence model to identify at least one learning objective of the user from the input provided by the user.

The term “second prompt” refers to a prompt generated by the processor for instructing a generative artificial intelligence model to perform an analysis of the input from the user, such as extracting features, context, or additional information relevant to learning.

The term “third prompt” refers to a prompt generated by the processor and input to a generative artificial intelligence model for causing the generative artificial intelligence model to select, based on an analysis result, at least one appropriate educational resource corresponding to a learning objective.

The term “fourth prompt” refers to a prompt generated by the processor for instructing a generative artificial intelligence model to dynamically update a learning path of the user in accordance with monitored learning progress of the user.

The term “fifth prompt” refers to a prompt generated by the processor for instructing a generative artificial intelligence model to extract at least one learning objective from input data of the user, the input data possibly including past or current user inputs.

The term “generative artificial intelligence model” refers to a machine learning model, such as a large language model or other generative model, that generates outputs including text or other data in response to prompts and is capable of performing tasks such as interpretation, analysis, and recommendation based on input data.

The term “learning objective” refers to a goal or target of learning specified or implied by the user, such as acquiring knowledge or skills in a particular subject, topic, or domain.

The term “analysis result” refers to information produced by the generative artificial intelligence model in response to a prompt requesting analysis of user input, the information including, for example, extracted topics, inferred user level, constraints, or other structured data.

The term “educational resource” refers to any content or material used for learning, including but not limited to online courses, lessons, textbooks, articles, videos, exercises, or digital learning objects.

The term “learning progress” refers to a state or measure indicating how far the user has advanced in using one or more educational resources or along a learning path, including, for example, completion rates, scores, or timestamps.

The term “learning path” refers to an ordered sequence of one or more educational resources or learning activities recommended to the user to achieve one or more learning objectives.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

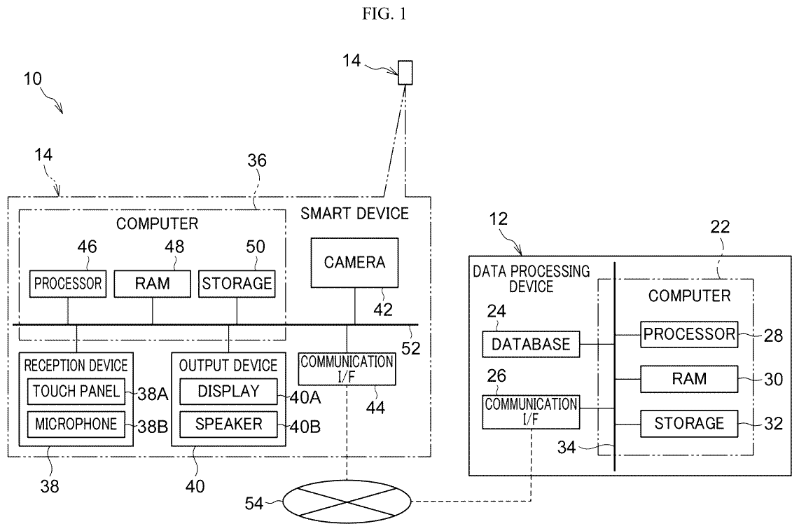

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

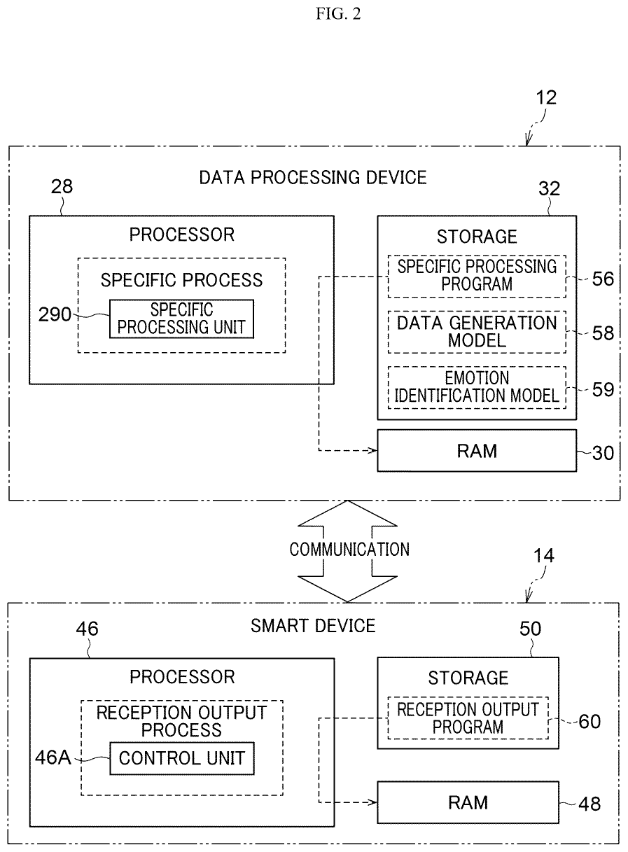

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems suffer from several technical limitations when attempting to personalize learning plans on the basis of natural language input from users. In many existing systems, user goals are captured through fixed-form questionnaires or static selection menus, and free-form text input is either not supported or is processed only by simple keyword matching or rule-based parsing. As a result, the system cannot reliably interpret nuanced natural language expressions of learning objectives, such as implicit prerequisites, desired depth, or constraints, and cannot structurally represent such objectives in a way that is suitable for subsequent automated processing.

In addition, known systems typically implement recommendation logic through static, hand-crafted rules or fixed scoring algorithms embedded in application code. When these systems attempt to recommend educational content or construct a learning path, they often rely on pre-defined mappings between a small set of user categories and a fixed list of learning resources. Consequently, the systems exhibit limited scalability and flexibility, and require costly and error-prone manual maintenance whenever new content or new learning objectives are introduced. This rigid architecture hampers the ability of the computing infrastructure to dynamically adapt to diverse learning objectives and heterogeneous content catalogs. Furthermore, many existing systems lack an integrated mechanism for using machine-learned language models as a general-purpose reasoning engine that operates over both user input and system-maintained history data. Even when large-scale language models are employed, they are often used in an ad hoc manner, for example to answer isolated natural language questions, without being systematically integrated into a loop that includes: (i) structured prompt construction from stored data, (ii) structured result parsing, (iii) storage of normalized representations, and (iv) re-prompting based on accumulated progress. This fragmented use of language models leads to unreliable outputs, inconsistent data structures, and duplication of logic between application code and external models, thereby reducing robustness and throughput of the overall computing system.

Moreover, conventional systems typically do not maintain a normalized representation of learning objectives and user skill profiles as standardized categories in a database that can be efficiently queried and updated. Absent such normalization, the system must repeatedly process raw text or loosely structured data, which increases processing latency, complicates indexing and retrieval, and prevents efficient use of database optimization techniques. This degrades the performance of the computing resources and impairs the ability to generate, update, and retrieve individualized learning paths in real time.

Also, the mechanisms for monitoring and reacting to user learning progress in known systems are often simplistic. Progress is usually tracked as a binary completion flag or coarse-grained percentage, and subsequent recommendations are derived through static look-up tables. This prevents the system from exploiting fine-grained telemetry such as completion rate trends, learning time per unit, or evaluation scores, and from using such telemetry in a feedback loop to dynamically modify the learning path. As a consequence, the underlying computing platform fails to fully leverage the available data to optimize resource selection and ordering for each user.

Accordingly, there is a need for an improved computer-implemented system and method that (i) converts unstructured natural language input from a user into structured learning objective data via interaction with a generative AI model, (ii) normalizes such data into standardized categories that are efficiently handled by storage and query mechanisms, (iii) uses structured prompt sentences to systematically orchestrate generative AI model calls for extraction, recommendation, and re-planning, and (iv) maintains and dynamically updates a learning path based on detailed progress history. Such a system should enhance the operation of the computer itself by improving how the processor stores, retrieves, and transforms data, by reducing reliance on hard-coded rule sets, and by integrating the generative AI model into a controllable, repeatable, and data-driven computation pipeline.

The specific processing by the specific processing unit 290 of the data processing device 12 in Example 1 is realized by the following means.

The present invention provides a server comprising a processor and a storage device, the processor being configured to receive, via a communication interface, natural language input data from an information processing terminal operated by a user, convert the input data into structured text data, generate, from the structured text data, structured prompt sentences to be supplied to a generative AI model, transmit the prompt sentences to the generative AI model, and obtain, from responses of the generative AI model, structured learning objective data including at least a learning objective and associated learning skills of the user; to normalize the structured learning objective data by selecting, on the basis of the structured learning objective data, at least one standardized learning category and at least one standardized skill category from standardized categories stored in a classification database, and to store resulting user profile data in the storage device; to search, on the basis of the user profile data, a learning material database stored in the storage device for a plurality of educational content candidates, to generate, from metadata of the educational content candidates, further prompt sentences to be supplied to the generative AI model, to transmit the further prompt sentences to the generative AI model, to obtain, from responses of the generative AI model, selection and ordering information for the educational content candidates, and to generate learning path data for the user on the basis of the selection and ordering information; to transmit the learning path data to the information processing terminal for presentation to the user; to receive, from the information processing terminal, progress event data indicating at least viewing, starting learning, completing learning, and evaluating of each educational content by the user, to store the progress event data as progress history data in the storage device, and to generate, from at least the progress history data and the user profile data, update prompt sentences to be supplied to the generative AI model, to transmit the update prompt sentences to the generative AI model, to obtain, from responses of the generative AI model, proposal data regarding modification or addition of the learning path, and to dynamically update the learning path data on the basis of the proposal data. This enables the server to implement an improved computer-implemented learning support process in which unstructured natural language user input is transformed into normalized, machine-tractable learning objective data; prompt sentences are systematically generated from internal data structures to control interactions with a generative AI model; learning resources are selected and ordered based on standardized user profiles; and learning paths are adaptively updated in real time according to detailed progress telemetry, thereby enhancing efficiency, scalability, and responsiveness of the underlying computing system.

The term “information processing terminal” refers to a computing apparatus operated by a user, such as a client device including at least a processor, a memory, a user interface, and a communication interface, which is configured to transmit and receive data to and from a server over a communication network.

The term “server” refers to an information processing apparatus including at least one processor, a memory, and a communication interface, which is configured to provide computational services, data storage, and processing functions to one or more information processing terminals over a communication network.

The term “processor” refers to one or more hardware processing units, such as a central processing unit, a graphics processing unit, or other processing circuitry, configured to execute instructions and perform arithmetic and logical operations on data stored in a memory.

The term “storage device” refers to a hardware component or subsystem, such as a semiconductor memory, a magnetic storage medium, or an optical storage medium, configured to non-transitorily store data and program instructions accessible by a processor.

The term “communication network” refers to any wired or wireless data communication infrastructure, including local area networks, wide area networks, and global networks, that enables data exchange between the server and one or more information processing terminals.

The term “natural language input data” refers to text data expressed in a human language, such as a sentence or phrase describing a user's intention or learning objective, which is received from the information processing terminal without being restricted to predefined command formats.

The term “structured text data” refers to text-based data that has been organized into a predefined format or schema, such as key-value pairs, fields, or markup, so that it can be programmatically parsed and processed by the processor.

The term “prompt sentence” refers to a structured sequence of natural language or machine-readable instructions generated by the processor and supplied to a generative AI model, which specifies a task to be performed by the generative AI model and may include input data, constraints, and output format requirements.

The term “generative AI model” refers to a machine-learned model trained using data-driven techniques, such as deep learning, which is configured to generate output data, including text or structured data, in response to input data such as prompt sentences.

The term “structured learning objective data” refers to data representing a user's learning objective and related attributes in a structured format according to a predefined schema, enabling the data to be stored, queried, and processed by the processor.

The term “learning objective” refers to an intended educational goal of the user, such as acquisition of knowledge or skills in a particular subject area or topic, which can be inferred or extracted from the user's natural language input.

The term “learning skills” refers to individual competencies, abilities, or topics associated with achieving a learning objective, such as knowledge of a specific programming language or understanding of a particular conceptual domain.

The term “classification database” refers to a data storage structure that stores a plurality of standardized categories and associated metadata, which can be referenced by the processor to normalize and categorize learning objectives and learning skills.

The term “standardized learning category” refers to a predefined category in the classification database representing a generalized or canonical form of a learning objective, enabling diverse user-specified objectives to be mapped to a common representation.

The term “standardized skill category” refers to a predefined category in the classification database representing a generalized or canonical form of a learning skill, enabling diverse skill descriptions to be mapped to a common representation.

The term “user profile data” refers to data associated with a particular user, including at least normalized representations of learning objectives and learning skills, and optionally including additional attributes such as learning level, preferences, or constraints.

The term “learning material database” refers to a data storage structure that stores data representing a plurality of educational contents, such as course records, document references, or media items, each associated with metadata including identification information, topic information, and difficulty information.

The term “educational content candidate” refers to an entry in the learning material database that represents a potentially relevant learning resource, such as a course, module, lesson, or other instructional material, which is considered by the processor for recommendation to the user.

The term “metadata” refers to descriptive data associated with an item, such as educational content, including at least an identifier, a title, a topic, a difficulty level, and optionally additional attributes such as duration or provider information.

The term “selection and ordering information” refers to data indicating which educational content candidates are recommended for the user and in what sequential order they are to be presented or undertaken as part of a learning path.

The term “learning path data” refers to structured data representing an ordered sequence of educational content items and related parameters, such as prerequisites or recommended progression, which define a personalized learning route for the user.

The term “display control data” refers to data generated by the processor and provided to the information processing terminal, specifying how learning path data and educational contents are to be visually or otherwise presented via a user interface.

The term “user interface” refers to a logical and physical arrangement of input and output components, such as screens, windows, buttons, and controls, through which a user interacts with an information processing terminal or server-provided functions.

The term “progress event data” refers to data indicating a state change or action related to the user's interaction with educational content, including events such as viewing, starting learning, completing learning, or evaluating the content.

The term “progress history data” refers to data that accumulates progress event data over time for a user, forming a historical record that describes the user's learning activities, completion status, performance, and temporal patterns.

The term “completion rate data” refers to data indicating the extent to which a user has completed a given educational content, expressed for example as a percentage or in another quantitative measure.

The term “learning time data” refers to data indicating an amount of time spent by the user engaging with a particular educational content or within a particular learning period.

The term “evaluation data” refers to data representing feedback or assessment associated with educational content, such as user ratings, scores, test results, or instructor evaluations.

The term “remedial educational content” refers to educational content intended to reinforce or review foundational concepts or skills in areas where the user's progress history data indicates weaknesses or deficiencies.

The term “difficulty-adjusted educational content” refers to educational content whose difficulty level has been selected or modified based on user-specific information, such as progress history data or user profile data, to be more suitable for the user's current capability.

The term “remedial section” refers to a segment of a learning path that includes remedial educational content inserted to improve the user's understanding of prerequisite concepts before advancing in the learning path.

The term “difficulty-changed section” refers to a segment of a learning path in which one or more educational contents have been replaced or reordered to adjust overall difficulty according to user-specific information.

The term “proposal data” refers to data generated by the generative AI model, in response to a prompt sentence, that specifies suggested modifications, additions, or reordering of educational contents within a learning path.

The term “modification or addition of the learning path” refers to operations performed on learning path data, including changing the order of contents, inserting new contents, removing contents, or adjusting content properties to better match the user's needs.

The term “relationship among a plurality of learning objectives” refers to logical or semantic associations between multiple learning objectives of a user, such as prerequisite relationships, overlapping topics, or hierarchical goal dependencies.

The term “priority among a plurality of learning objectives” refers to a relative importance or recommended sequencing of multiple learning objectives of a user, which may determine the order in which associated learning paths are generated or presented.

The term “reconstruct” refers to an operation by which the processor modifies existing standardized learning categories, learning path data, or both, based on new information, to generate an updated configuration that better reflects the user's current objectives and status.

In one embodiment, a server cooperates with one or more terminals to implement a computer-implemented learning support system that converts natural language input from a user into structured learning objective data, generates a personalized learning path, and dynamically updates the learning path based on detailed progress data. The server includes at least one processor, a memory, a storage device, and a communication interface. The terminal includes at least one processor, a memory, a user interface, and a communication interface.

The server uses commercially available hardware, such as a rack-mounted x86-64 server with a multi-core central processing unit (CPU) and optionally one or more graphics processing units (GPUs). The server runs an operating system, such as a UNIX-like operating system, and executes an application server framework, such as an HTTP server process implemented using a general web framework. The server accesses a relational database management system, such as a structured query language (SQL) database, to store user profile data, classification data, learning material metadata, and progress history data. The server communicates with a generative AI model hosted either locally on GPU hardware or remotely via a network-accessible inference endpoint.

The terminal uses general-purpose computing hardware, such as a smartphone, tablet, or personal computer, executing an operating system, such as a mobile operating system or a desktop operating system. The terminal executes an application that provides a graphical user interface for receiving natural language text from the user, displaying recommended learning content, and transmitting progress events to the server. The terminal uses an operating system networking stack to exchange data with the server over a communication network using HTTPS.

The server uses a generative AI model that is implemented as a deep neural network, for example a transformer-based language model comprising a plurality of self-attention layers, feed-forward layers, and layer normalization modules. The generative AI model is trained in advance on a large text corpus using a language modeling objective. In one embodiment, the server uses a model that receives as input a tokenized prompt sentence and outputs a probability distribution over tokens at each position. The model uses multi-head attention with learned weight matrices, and the model parameters are adjusted by gradient descent using a loss function such as cross-entropy between predicted tokens and ground truth tokens during training. The model is fine-tuned on a dataset of educational dialogues and curriculum-planning examples so that the model can map natural language descriptions of learning objectives and course metadata to structured outputs in a constrained format. The server generates prompt sentences that instruct the generative AI model to perform specific, structured tasks. In one embodiment, the server constructs prompt sentences that explicitly define input fields, output fields, and formatting requirements, thereby constraining the output of the generative AI model into a machine-tractable structure. Because the prompt sentences are systematically generated from internal data structures, the server can guarantee that each call to the generative AI model corresponds to a well-defined transformation of data, rather than an ad hoc user-level interaction.

For example, when the user enters a learning objective in natural language at the terminal, the terminal sends the text to the server. The server then generates a prompt sentence such as:

System: You are an educational planning assistant.

User: The user says: “I want to learn data science.”

Task: Extract the learning goals, required skills, assumed level, and constraints from the user's statement.

Output format: Return the result as plain text with labeled fields “goals:”, “skills:”, “level:”, and “constraints:”.

The generative AI model receives this prompt sentence as a sequence of tokens. The model transforms the token sequence through successive transformer layers. Each attention head computes attention scores based on query, key, and value vectors derived from the input tokens, and the resulting weighted sums propagate through non-linear feed-forward networks. The final output layer computes a probability distribution over the token vocabulary for each position, and the server decodes the most probable sequence matching the required tagged structure. The server then parses the labeled fields from the decoded text to create a structured learning objective data object containing fields such as a normalized goal description, a set of skill descriptors, a level designation, and any constraints.

The server stores the structured learning objective data in the storage device and normalizes it by mapping each free-text descriptor to a standardized learning category and standardized skill category. The server maintains a classification database with tables that define canonical categories, such as broad subject areas, skill families, difficulty levels, and prerequisite relationships. The server may compute similarity scores using vector representations of text (e.g., embeddings generated by an auxiliary encoder or by the same generative AI model) and may select the category whose vector representation is closest to the embedding of the extracted descriptor under a cosine similarity or Euclidean distance measure. This normalization with standardized categories enables efficient indexing, query optimization, and cache utilization in the database engine, leading to reduced latency in subsequent retrievals.

The server then uses the normalized user profile data to query a learning material database. The learning material database stores, for each educational content item, metadata fields such as a unique identifier, a title, topic tags, standardized category tags, difficulty level, estimated duration, and prerequisite relationships. The server uses structured queries that filter and join based on the standardized tags and difficulty levels, thereby reducing search space and allowing the use of database indexes to speed up retrieval. This structured search is more efficient than scanning raw text descriptions and avoids repeated natural language parsing at query time.

To determine a recommended learning path, the server generates another prompt sentence that describes the user's goal, level, and the candidate courses. For example:

System: You are an educational planner.

User profile: beginner, goal is “learn the basics of data science”.

Available courses:
(1) “Python for Absolute Beginners” (skills: Python basics, level: beginner)
(2) “Introduction to Statistics” (skills: basic statistics, level: beginner)
(3) “Intro to Data Science” (skills: Python, statistics, data visualization, level: intermediate)

Task: Propose an ordered learning path using these courses.

Output format: Return a list of steps, each step specifying a course number, a short reason, and any prerequisites.

The generative AI model processes this prompt and outputs a structured explanation indicating an order such as (1) then (2) then (3), with reasons referencing prerequisite skills. The server parses the output to construct learning path data as a structured sequence of references to educational content items, along with associated justifications and prerequisite edges. The server stores the learning path data in the storage device and transmits a simplified representation to the terminal for presentation.

When the user interacts with the recommended educational content, the terminal generates progress event data, including timestamps, completion flags, quiz scores (when available), and evaluation ratings. The terminal sends this data to the server. The server aggregates these events into progress history data, computing metrics such as completion rate per content, average time per unit, and recent performance trends. Because this aggregation is executed on normalized identifiers and standardized fields, the server can apply efficient analytical queries and incremental updates rather than recomputing from raw logs.

The server then uses the progress history data together with the user profile data to generate update prompt sentences that instruct the generative AI model to analyze whether the user should proceed, review, or change difficulty. For example:

System: You are an adaptive learning planner.

User status:
Completed “Python for Absolute Beginners” with high quiz scores and short completion time.
Not started “Introduction to Statistics” and “Intro to Data Science”.

Goal: learn the basics of data science.

Task: Decide whether the user should proceed to “Introduction to Statistics”, add remedial

Python content, or skip directly to “Intro to Data Science”.

Output format: Provide a recommendation with one of “proceed”, “add_remedial”, or “skip”, and a short justification.

The generative AI model evaluates the prompt in light of the training it received on learning progression patterns and outputs a recommendation. The server interprets the recommendation token (for example, “proceed”) and updates the learning path data by confirming the next step or inserting additional remedial or advanced content as suggested. This architecture produces a technical improvement over conventional systems in multiple ways. First, the server performs a systematic transformation from unstructured natural language to structured, normalized data that can be indexed and queried efficiently. This transformation reduces storage redundancy and enables query optimizations, such as index scans and precomputed join strategies, thereby improving processing speed and reducing computational overhead for subsequent recommendations.

Second, by encoding the interactions with the generative AI model as structured prompt sentences that specify both content and format, the server obtains outputs that are predictable and machine-tractable. This reduces parsing errors, minimizes the need for heuristic post-processing, and improves the accuracy and stability of the overall recommendation pipeline. The generative AI model is not used merely as a generic text generator but is integrated as a controlled transformation module that converts well-defined input fields into well-defined output fields under strict formatting constraints.

Third, the server leverages progress history data in a fine-grained manner. Instead of simply marking a course as complete or incomplete, the server continuously updates per-content metrics and uses these metrics in subsequent prompt sentences. This allows the generative AI model to react to subtle patterns, such as unusually long completion times or low evaluation scores, and propose non-trivial modifications to the learning path. Because the server manages the storage, compression, and retrieval of this detailed telemetry efficiently in its database, the system can scale to a large number of users without experiencing excessive latency or resource consumption.

Fourth, the system achieves a non-conventional integration of rule-based processing and model-based reasoning. The server enforces deterministic constraints through its database schema, category normalization, and fixed interpretation of tokens such as “proceed” or “add_remedial”. At the same time, the generative AI model provides flexible reasoning about natural language goals and educational content relationships. The server thus distributes responsibilities between symbolic and statistical components in a way that improves consistency and throughput compared to either a purely rule-based or purely model-based approach.

Fifth, the generative AI model itself is configured and trained in a manner that improves its usability in this structured setting. The training procedure may include supervised fine-tuning on examples of learning objective extraction, category mapping, and curriculum generation, where each training instance contains an input prompt sentence and a target output that strictly follows a labeled format. The error function during fine-tuning may incorporate penalties not only for token-level mismatches but also for structural deviations from the required labels, thereby biasing the model toward outputs that are easier to parse. The training may also use data augmentation methods that introduce variations in user phrasing, misspellings, or incomplete descriptions, which improves robustness and reduces error rates when dealing with real-world user input.

Sixth, the server can implement alternative embodiments of the generative AI model and processing pipeline. In one variation, the generative AI model is deployed locally on the same server hardware, and the server uses GPU-based acceleration to execute inference. In another variation, the generative AI model runs on a separate inference server, and the main server communicates via a dedicated internal network. In another embodiment, the server uses a smaller, distilled model for frequent, low-latency tasks such as skill extraction, and uses a larger, more accurate model only for complex path re-planning, thereby optimizing computational resources and reducing communication load.

Seventh, the server can vary the internal data structures and algorithms while preserving the essential operation. In one embodiment, the classification database uses a relational schema with tables for categories, skills, and mappings, while in another embodiment a graph database is used to represent prerequisite and dependency relationships between categories and contents, enabling faster traversal when generating multi-step learning paths. In another embodiment, the server uses a caching mechanism that stores recently accessed user profiles and learning paths in an in-memory data store, reducing latency when the user revisits the system.

The terminal can also vary in implementation. In one embodiment, the terminal runs a native mobile application that renders the learning path as a scrollable list with visual indicators of completion, while in another embodiment the terminal runs a web browser and uses web technologies to display the learning path. In any case, the terminal interacts with the server via defined application programming interfaces and transmits and receives structured data representing user input, profile identifiers, and path updates. Because the intensive natural language processing and optimization are performed at the server, the terminal hardware requirements remain modest.

The described system is not limited to simple automation of human curriculum design. The system improves the functioning of the computer network by introducing a specialized pipeline that transforms user-authored natural language into normalized, indexed representations, and by orchestrating interactions with a generative AI model via structured prompt sentences and constrained outputs. These technical features reduce the need for heavy client-side processing, minimize redundant parsing, lower the frequency of malformed or unusable responses, and provide deterministic interpretation paths. As a result, the server can respond to user requests more quickly, with fewer errors, and with better scalability than conventional architectures that rely either on manual curation or ad hoc use of language models.

In sum, the server, the terminal, and the user cooperate in a system in which the processor-controlled transformation of data, the design of prompt sentences, the structured parsing and normalization, and the dynamic update of learning paths collectively yield improvements in accuracy, speed, resource utilization, and robustness of computer-based learning support, thereby providing a concrete technical implementation rather than an abstract business method.

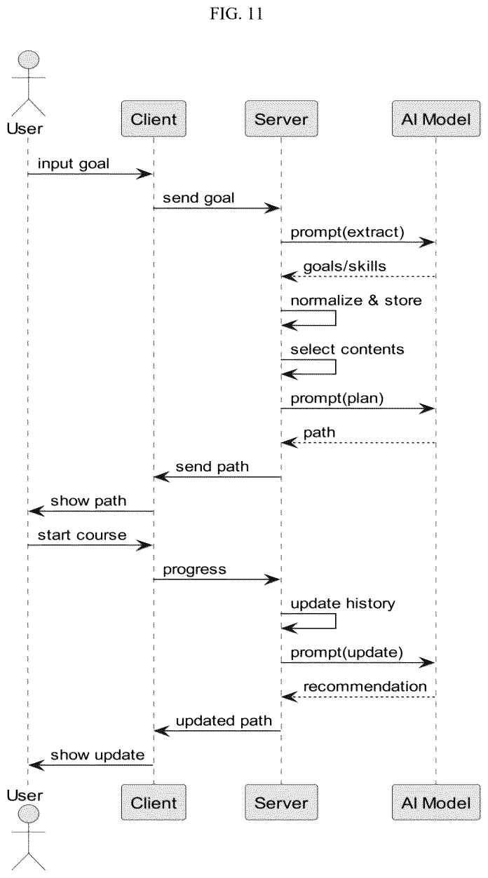

The following describes the processing flow using FIG. 11.

### Step 1:

The user inputs a learning objective.

The user operates the terminal and enters a natural language sentence such as “I want to learn data science.” into a text input field of a learning-support application. The terminal receives this raw text as input. The terminal validates that the text is non-empty, encodes the text as UTF-8, attaches a user identifier and timestamp, and constructs a structured request object.

The output of this step is structured input data containing at least the user ID and the natural language text.

### Step 2:

The terminal transmits the input data to the server.

The terminal uses an operating system networking stack to send the structured input data to the server via HTTPS. The input of this step is the structured input data generated in Step 1.

The terminal encapsulates the data in an HTTP request message addressed to a predefined API endpoint of the server and transmits the message over a communication network. The output of this step is an incoming HTTP request received by the server that contains the user's natural language text and associated metadata.

### Step 3:

The server parses and logs the received input.

The server receives the HTTP request containing the user's learning objective. The input of this step is the HTTP request message. The server uses a web framework to parse the message body, extract fields such as the user ID and the natural language text, and validate the presence and type of these fields. The server writes a record containing the raw text, the user ID, and a reception timestamp into a storage device, such as a relational database. The output of this step is a validated, stored raw input record and an internal representation of the user's request.

### Step 4:

The server generates an extraction prompt sentence for the generative AI model.

The server uses the internal representation of the user's text as input. The server inserts the text into a predefined template that specifies a task and an output format. The server constructs a prompt sentence, for example:

System: You are an educational planning assistant.

User: The user says: “I want to learn data science.”

Task: Extract the learning goals, required skills, assumed level, and constraints from the user's statement.

Output format: Return the result as plain text with labeled fields “goals:”, “skills:”, “level:”, and “constraints:”.

The server concatenates the system and user parts into a single string and optionally normalizes whitespace. The output of this step is a fully formed prompt sentence that conforms to an internal extraction template.

### Step 5:

The server sends the extraction prompt to the generative AI model and receives a response.

The server uses the prompt sentence generated in Step 4 as input. The server encodes the prompt as tokens using the tokenizer associated with the generative AI model and sends an API request to a model inference endpoint over HTTPS. The generative AI model executes a series of transformer layers that apply attention and feed-forward computations to the tokens and generates an output token sequence representing the extracted information in the requested labeled format. The server receives the output token sequence, decodes it into text, and stores the raw model response. The output of this step is a response text that contains labeled fields for goals, skills, level, and constraints.

### Step 6:

The server parses the model response into structured learning objective data.

The server uses the response text from Step 5 as input. The server scans the text to locate the labeled prefixes “goals:”, “skills:”, “level:”, and “constraints:”, and extracts the text segments following each label. The server splits list-like segments at separators such as commas or line breaks to obtain arrays of goal descriptions and skill descriptions. The server populates an internal data structure with fields for goals, skills, level, and constraints. The output of this step is structured learning objective data that can be programmatically accessed by field name.

### Step 7:

The server normalizes learning objectives and skills into standardized categories. The server uses the structured learning objective data as input. For each goal and each skill description, the server computes a vector representation using an embedding function associated with the generative AI model or another encoder. The server retrieves vector representations of standardized learning categories and standardized skill categories from a classification database. The server computes similarity scores, for example cosine similarity, between each user-derived vector and each category vector, and selects the category with the highest similarity above a predefined threshold. The server associates the selected category identifiers with the user and stores the resulting user profile data, including standardized category IDs and level, in the storage device. The output of this step is normalized user profile data linked to the user ID.

### Step 8:

The server retrieves candidate educational content from a learning material database.

The server uses the user profile data, including standardized learning categories and skill categories, as input. The server formulates database queries that filter educational content by matching category IDs, difficulty level, and optionally constraints such as duration. The server executes these queries on a learning material database and obtains a list of educational content candidates. The server extracts metadata fields for each candidate, such as identifier, title, tags, difficulty, and estimated duration. The output of this step is a set of educational content candidate records with associated metadata.

### Step 9:

The server generates a planning prompt sentence for the generative AI model.

The server uses the user profile data and the educational content candidate metadata as input.

The server constructs a prompt sentence describing the user's goal, level, and the list of available courses. For example:

System: You are an educational planner.

User profile: beginner, goal is “learn the basics of data science”.

Available courses:
(1) “Python for Absolute Beginners” (skills: Python basics, level: beginner)
(2) “Introduction to Statistics” (skills: basic statistics, level: beginner)
(3) “Intro to Data Science” (skills: Python, statistics, data visualization, level: intermediate)

Task: Propose an ordered learning path using these courses.

Output format: Return a list of steps, each step specifying a course number, a short reason, and any prerequisites.

The server serializes the candidate list into text lines within the prompt and ensures consistent numbering and labels. The output of this step is a planning prompt sentence that encodes both user state and candidate options.

### Step 10:

The server sends the planning prompt to the generative AI model and receives a recommended order.

The server uses the planning prompt sentence from Step 9 as input. The server tokenizes the prompt and sends it to the generative AI model over the network. The generative AI model processes the tokens with its internal attention and feed-forward layers and generates an output describing a recommended order and reasoning, formatted as instructed. The server decodes the response into text and stores it temporarily in memory. The output of this step is a recommended learning path description containing course numbers, textual reasons, and any prerequisite indications.

### Step 11:

The server converts the recommended order into learning path data.

The server uses the model response text from Step 10 as input. The server parses the text to identify each step, extract the referenced course number, and map the course number back to the corresponding course identifier from the candidate list. The server constructs a sequence of learning steps, each containing a content identifier, an execution order index, and optional prerequisite references derived from the text. The server stores this sequence as learning path data associated with the user ID in the storage device. The output of this step is a structured learning path data object ready for transmission to the terminal.

### Step 12:

The server transmits the learning path data to the terminal.

The server uses the structured learning path data as input. The server converts the learning path data into a format suitable for the terminal, including course identifiers, titles, short reasons, and order indices. The server packages this data into a response message and sends it via HTTPS to the terminal's API client. The output of this step is a response message received by the terminal containing the individualized learning path.

### Step 13:

The terminal presents the learning path to the user.

The terminal uses the response message from Step 12 as input. The terminal parses the message to reconstruct the ordered list of learning steps. The terminal creates user interface components that display each step's title, brief description, and current status (for example, “not started”). The terminal may generate clickable elements to allow the user to start each course. The output of this step is a rendered learning path on the terminal's display, visible to the user.

### Step 14:

The user interacts with the educational content and generates progress.

The user uses the terminal to select a recommended course and start learning. The input of this step is the displayed list of learning steps. The user taps or clicks a course entry, and the terminal opens a web view or an external link to the content provider. As the user progresses, the user completes lessons and may submit answers to assessments. The output of this step is a series of user actions that are observed and recorded by the terminal as progress events, such as “course started,” “lesson completed,” and “course completed.”

### Step 15:

The terminal reports progress events to the server.

The terminal uses the locally recorded progress events and associated metadata (user ID, course ID, timestamps, scores) as input. The terminal batches or streams these events to the server as structured messages via HTTPS. The terminal may compress or group multiple events to reduce communication overhead. The output of this step is a set of progress event messages delivered to the server.

### Step 16:

The server aggregates progress events into progress history data.

The server uses the progress event messages from Step 15 as input. The server writes each event into a progress log table and updates aggregate fields for each user-course pair, such as completion percentage, most recent access time, and average score. The server may compute derived metrics, such as time spent per lesson or rate of completion over time, by applying arithmetic operations on timestamps and counters. The output of this step is updated progress history data stored in the storage device.

### Step 17:

The server generates an update prompt sentence based on progress history.

The server uses the progress history data and the existing learning path data as input. The server selects relevant metrics for the current or next step in the path, such as whether the course is fully completed and the associated performance indicators. The server inserts this information into a predefined template to create an update prompt sentence, for example:

System: You are an adaptive learning planner.

User status:
Completed “Python for Absolute Beginners” with high quiz scores and short completion time.
Not started “Introduction to Statistics” and “Intro to Data Science”.

Goal: learn the basics of data science.

Task: Decide whether the user should proceed to “Introduction to Statistics”, add remedial Python content, or skip directly to “Intro to Data Science”.

Output format: Provide a recommendation with one of “proceed”, “add_remedial”, or “skip”, and a short justification.

The output of this step is an update prompt sentence that encapsulates the current user status and decision options.

### Step 18:

The server sends the update prompt to the generative AI model and receives a recommendation.

The server uses the update prompt sentence from Step 17 as input. The server tokenizes the prompt, sends it to the generative AI model, and waits for an inference result. The generative AI model computes attention over the tokens, applies its learned weights, and outputs a textual recommendation such as “proceed: The user performed well, so continue with ‘Introduction to Statistics’.” The server decodes and stores this response text. The output of this step is a recommendation containing a decision token and a justification.

### Step 19:

The server updates the learning path data based on the recommendation.

The server uses the recommendation text from Step 18 and the current learning path data as input. The server parses the recommendation to detect the decision token (for example, “proceed,” “add_remedial,” or “skip”). If the decision is “proceed,” the server marks the next course as active. If the decision is “add_remedial,” the server searches the learning material database for remedial content matching the relevant skill categories, inserts these contents into the path before the next core course, and updates order indices. If the decision is “skip,” the server adjusts the path to bypass the intermediate course. The output of this step is a modified learning path data object reflecting the updated sequence of content.

### Step 20:

The server transmits the updated learning path to the terminal.

The server uses the modified learning path data from Step 19 as input. The server prepares a delta or full update message that describes changed steps, new steps, or removed steps. The server sends this message via HTTPS to the terminal. The output of this step is an update message received by the terminal indicating how the learning path has changed.

### Step 21:

The terminal refreshes the displayed learning path.

The terminal uses the update message from Step 20 as input. The terminal applies the changes to its internal representation of the learning path, marking completed steps, inserting new remedial steps if any, or skipping certain steps as instructed. The terminal redraws the user interface to show the updated order, and may highlight the newly recommended next course and the explanation text. The output of this step is an updated visual learning path presented to the user, which reflects the dynamic adaptation performed by the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented learning support systems, a server typically applies fixed rules or simple keyword matching to user input in order to identify learning goals and retrieve corresponding educational resources. Such approaches often treat natural language input as a static query string, without fully exploiting contextual meaning, user proficiency, and evolving progress states. As a result, the server cannot flexibly adapt its behavior as new information is received, and the quality of recommended learning paths is limited by static logic hard-coded by developers.

Furthermore, known systems that incorporate a generative AI model frequently use the model in a narrow way, for example only to generate explanations or only to answer direct questions, while core control logic for goal identification, resource selection, and path updating remains separate and rule-based. In such architectures, the generative AI model is not integrated into the main decision loop as a programmable component controlled via prompt sentences. Consequently, the server must maintain complex algorithmic code paths for interpretation, ranking, and adaptation, which increases implementation complexity and reduces maintainability and scalability.

Additionally, in many existing solutions, progress tracking is performed as a simple logging function, and dynamic updates to a learning path are limited to trivial operations, such as unlocking the next fixed item in a predefined sequence. These systems do not use progress information as structured input to a generative AI model and do not encode update conditions and update contents as machine-interpretable prompt sentences. Therefore, the server is unable to leverage the generative AI model to jointly reason over user goals, resource metadata, and evolving progress data in a unified inference process.

From the perspective of computer technology, these limitations lead to suboptimal utilization of computing resources and machine learning models. The server executes multiple disjoint processing pipelines for natural language understanding, database querying, recommendation, and explanation, each with its own logic and data structures. This fragmentation degrades processing efficiency, increases latency, and complicates the design of scalable APIs between components. Moreover, the server cannot systematically update its behavior without modifying program code, because generative AI is not used as a configurable decision engine driven by prompt sentences that encode decision criteria and context.

There is therefore a need for an improved computer-implemented system and method that reconfigures the processing architecture of the server so that: (i) user goal information expressed in natural language is normalized and converted into machine-usable attributes; (ii) these attributes, together with resource metadata and progress data, are injected into structured prompt sentences; and (iii) a generative AI model is used as a central reasoning component not only for natural language generation but also for selection, ranking, and dynamic reconstruction of learning paths. Such an arrangement should reduce the amount of hard-coded control logic in the server, improve the efficiency and flexibility of recommendation processing, and enable the server to adapt its behavior by modifying prompt design rather than rewriting core algorithms.

The specific processing by the specific processing unit 290 of the data processing device 12 in Application Example 1 is realized by the following means.

The present invention provides a server comprising a processor configured to receive goal information expressed in natural language from a user-side information processing apparatus, normalize the goal information, and store the normalized goal information as an analysis target string; to generate a prompt sentence including instruction information for converting the analysis target string into a representation vector or a classification result by use of a natural language processing learning model, input the prompt sentence into a generative information processing model, and obtain analysis result information from the generative information processing model; to set search conditions for an information storage apparatus that stores education resource information on the basis of the analysis result information, acquire candidate education resource information from the information storage apparatus, and rank the candidate education resource information according to the analysis result information to construct learning path information; to generate a prompt sentence including the analysis result information and the candidate education resource information in order to cause the generative information processing model to generate the learning path information and reasons for presenting respective education resources, input the prompt sentence into the generative information processing model, and obtain explanation text information from the generative information processing model; to transmit the learning path information and the explanation text information to the user-side information processing apparatus so that the learning path information and the explanation text information are presented on the user-side information processing apparatus; to record learning execution status information received from the user-side information processing apparatus in a progress information storage apparatus, and perform condition determination for updating the learning path information on the basis of progress information recorded in the progress information storage apparatus; and to determine a next education resource to be presented on the basis of the progress information and updated learning path information, generate a prompt sentence for causing the generative information processing model to generate update explanation information including a content of the determination and a reason for the update, input the prompt sentence into the generative information processing model, and obtain the update explanation information from the generative information processing model. This enables an improvement in computer technology in that the generative information processing model is integrated into the main control loop of the server as a prompt-driven reasoning engine, thereby reducing reliance on rigid rule-based logic, unifying natural language understanding, resource selection, and path updating in a single generative framework, and enhancing processing efficiency, scalability, and adaptability of the learning support system.

The term “user-side information processing apparatus” refers to an information processing device operated by a user, such as a terminal including a computing unit, an input unit, an output unit, and a communication unit, which is configured to transmit user input and receive data from a server via a communication network.

The term “goal information” refers to information expressing, in natural language or a similar human-readable form, an intended learning objective, learning field, skill target, or other user intention regarding learning that is input by the user through the user-side information processing apparatus.

The term “natural language processing learning model” refers to a machine learning model trained on language data, which is configured to process a character string or token sequence and to output at least one of a representation vector, a classification result, a probability distribution, or extracted feature values indicating semantic or syntactic characteristics of the input.

The term “analysis target string” refers to a normalized character string obtained from goal information or other user-provided text, which is stored in a format suitable for processing by the natural language processing learning model and by a generative information processing model.

The term “representation vector” refers to a numerical vector or similar structured numerical data output by the natural language processing learning model, which represents semantic, syntactic, or contextual features of an analysis target string or other textual input in a form suitable for similarity computation, clustering, or downstream decision processing.

The term “classification result” refers to an output of the natural language processing learning model indicating one or more categories, labels, or classes assigned to an analysis target string, such as learning domain categories, proficiency levels, or skill types, optionally with associated scores or probabilities.

The term “generative information processing model” refers to a machine learning model that is configured to generate text or other structured outputs in response to input data and instruction information included in a prompt sentence, and that is capable of performing at least one of reasoning, summarization, classification, recommendation, or explanation generation based on such input.

The term “prompt sentence” refers to an input data structure, typically expressed as a text sequence or a structured sequence of tokens, that includes at least one of instruction information, context information, user data, resource metadata, or progress data, and that is supplied to the generative information processing model to control its processing behavior and output content.

The term “analysis result information” refers to information obtained from the generative information processing model or the natural language processing learning model as a result of processing an analysis target string or related prompt sentence, including at least one of extracted attributes, categories, scores, representation vectors, or other intermediate or final inference results.

The term “information storage apparatus” refers to a storage subsystem, such as a database system, a file system, or a distributed storage system, which stores education resource information, progress information, and related metadata, and which can be accessed by the processor of the server for reading and writing data.

The term “education resource information” refers to information describing learning materials, such as courses, lessons, modules, exercises, or other instructional content, including at least one of titles, descriptions, difficulty levels, prerequisites, durations, and identifiers used for retrieval and presentation.

The term “candidate education resource information” refers to a subset of education resource information selected from an information storage apparatus according to search conditions or filtering criteria derived from analysis result information or other contextual information, and regarded as candidates for recommendation.

The term “learning path information” refers to structured information that defines an ordered or partially ordered sequence of education resources to be presented to a user, including at least one of resource identifiers, sequence positions, dependency relationships, and rationale data for such ordering.

The term “explanation text information” refers to natural language text or similar human-readable information generated by the generative information processing model, which explains at least one of recommended education resources, a constructed learning path, or reasons for presenting particular resources to the user.

The term “learning execution status information” refers to information indicating a user's progress with respect to one or more education resources, including at least one of completion flags, timestamps, scores, viewed portions, or other indicators of learning activity performed via the user-side information processing apparatus.

The term “progress information storage apparatus” refers to an information storage apparatus that is configured to store and manage learning execution status information for one or more users, and to provide such information to the processor for use in updating learning path information.

The term “progress information” refers to aggregated or structured information derived from learning execution status information stored in the progress information storage apparatus, including at least one of completed resources, uncompleted resources, completion percentages, or derived indicators used for decision making by the processor.

The term “update conditions” refers to conditions, rules, or criteria used by the processor to determine whether and how to modify learning path information, such as thresholds based on progress information, performance indicators, or elapsed time, which can be encoded or included within a prompt sentence.

The term “update contents” refers to configuration information or operation specifications indicating concrete modifications to be applied to learning path information, such as reordering uncompleted education resources, inserting new education resources, or removing redundant resources.

The term “update explanation information” refers to natural language text or similar information generated by the generative information processing model that explains, to a user or another component, at least one of a selected next education resource, a modification applied to a learning path, or reasons for such modification based on progress information and analysis result information.

The term “learning domain attribute” refers to an attribute indicating a field or subject area, such as programming, data analysis, or language learning, that is extracted from an analysis target string by the natural language processing learning model or by processing of analysis result information.

The term “proficiency attribute” refers to an attribute indicating an estimated skill level, such as beginner, intermediate, or advanced, derived from an analysis target string or related user data by the natural language processing learning model or by processing of analysis result information.

The term “related skill attribute” refers to an attribute indicating one or more specific skills associated with a user's learning goal, such as a programming language, a mathematical concept, or a domain-specific tool, extracted from an analysis target string or related context by the natural language processing learning model or by processing of analysis result information.

The term “feature amount calculation” refers to a computation performed by the natural language processing learning model or by associated processing routines, which calculates numerical features, embeddings, or other structured indicators from an analysis target string to enable extraction of attributes, classification, or similarity measurement.

The term “server” refers to an information processing apparatus including at least one processor and at least one memory, configured to communicate with one or more user-side information processing apparatuses via a network, and to execute processes including generation of prompt sentences, interaction with the generative information processing model, retrieval and updating of stored information, and transmission of results to the user-side information processing apparatuses.

In one embodiment, a server, one or more terminals, and a communication network together constitute a learning support system that implements the claimed invention. The server includes at least one processor, at least one main memory, a non-volatile storage device, and a network interface. The server executes server-side software including an operating system, a web application framework, a database access layer, and machine learning modules. The terminal includes a processor, a memory, a display device, one or more input devices, and a wireless or wired communication interface. The terminal executes a client application that exchanges data with the server using a prescribed communication protocol.

The server stores, in a storage subsystem such as a relational database management system, education resource information including course identifiers, lesson identifiers, textual titles, textual descriptions, difficulty levels, prerequisite relationships, expected duration, and metadata for vector representation. The server also stores, in a progress information storage apparatus such as a cloud-based key-value store or document store, learning execution status information per user and per resource, including completion flags, timestamps, assessment scores, and derived completion percentages. The server further stores, in a model storage area, parameters of a natural language processing learning model and a generative AI model.

The server uses a natural language processing learning model that includes a neural network having a multilayer architecture. In one embodiment, the neural network is a Transformer-based architecture including an input embedding layer, a plurality of self-attention layers, feed-forward sublayers, and a final pooling or classification layer. The server constructs a token embedding for each token in an analysis target string, adds positional encodings, and processes the sequence through multiple attention heads. The server obtains a representation vector as an output of a pooling operation over hidden states, or obtains a classification result as an output of a linear layer and a softmax function applied to the pooled state. The server trains the natural language processing learning model in advance using a training dataset of natural language goal sentences, education domain labels, proficiency labels, and skill labels. The server uses a supervised learning procedure that minimizes a cross-entropy loss function between predicted label distributions and ground truth labels, and updates model parameters using a gradient descent-based optimization algorithm. The server performs weight updates using backpropagation through the network layers. The server may apply data augmentation such as paraphrasing, synonym replacement, or random masking of tokens to increase robustness of the model to variations in user input. The server thereby configures the natural language processing learning model to output feature amounts suitable for learning domain attribute, proficiency attribute, and related skill attribute extraction.

The server uses a generative AI model that is also implemented as a neural network, for example an auto-regressive language model including an embedding layer, a plurality of masked self-attention layers, and an output projection layer that generates probability distributions over a token vocabulary. The server trains or fine-tunes the generative AI model on prompt-response pairs that encode tasks such as summarization of learning goals, explanation of learning paths, justification of resource selection, and reasoning about next recommended steps. The server defines a loss function, for example a negative log-likelihood of the correct output tokens given the input prompt tokens, and updates the model parameters using gradient descent and backpropagation. The server may perform instruction tuning by including multiple instruction formats and example outputs in the training data so that the generative AI model learns to follow a variety of prompt sentences that specify different reasoning tasks.

The terminal executes a client application implemented, for example, as a native mobile application or a web application running within a browser. The terminal displays an input field and guidance text, and the terminal accepts natural language input describing a learning goal from the user. The user operates the terminal to enter free-form text, such as “I want to learn data science,” “I need to improve my statistics for machine learning,” or “I am an intermediate programmer and want to start deep learning.” The terminal may perform basic local validation such as checking character length, allowed character set, and empty input detection.

The terminal converts the user input into a structured message including at least the user identifier and the goal text, and the terminal transmits the message to the server via a secured network connection. The terminal receives, from the server, learning path information and explanation text information, and the terminal displays a list of recommended courses, modules, or content items in an ordered manner using a graphical user interface. The user operates the terminal to select recommended items, to start content playback, or to answer embedded quizzes. The terminal records local events such as lesson start and completion, and the terminal transmits these events as learning execution status information to the server.

The server receives the natural language goal information from the terminal and normalizes the input. The server converts the character encoding into a unified internal format, performs Unicode normalization, and may perform language detection if the system supports multiple languages. The server stores the normalized text as an analysis target string in a character field of a persistence layer, thereby enabling re-use of the same text for later analysis or recomputation.

The server feeds the analysis target string into the natural language processing learning model by first applying a tokenizer that segments the string into tokens and maps the tokens into token identifiers. The server constructs token sequences and attention masks, and the server loads the model parameters into memory. The server then performs inference by applying matrix multiplications, attention weight computation, and non-linear activation functions across multiple layers. The server obtains a representation vector such as a fixed-length dense vector corresponding to the analysis target string, and the server obtains classification logits corresponding to learning domain categories, proficiency levels, and skill types.

The server computes softmax functions over the classification logits to obtain probability distributions for each attribute type. The server then selects attribute values based on probability thresholds or top-k criteria. For example, the server may select “data science” as a learning domain attribute if the predicted probability exceeds a preset threshold, select “beginner” as a proficiency attribute, and select “programming language: Python” and “statistics” as related skill attributes. The server thereby converts unstructured natural language input into a structured attribute representation suitable for subsequent database queries and prompt construction.

The server then performs search and ranking of education resources. The server stores, for each education resource, a precomputed representation vector obtained by applying the same or similar embedding process to resource descriptions. The server stores such vectors in a vector index, for example as floating-point arrays in a column of a database table or in a dedicated vector search engine. The server calculates similarity scores, such as cosine similarity or inner product, between the user goal representation vector and each candidate resource vector. The server also considers classification-based attributes, such as domain and proficiency level, and filters or re-weights candidate resources accordingly.

The server combines similarity metrics, attribute match scores, and explicit business rules in a ranking algorithm. The server may use a linear combination of cosine similarity scores and level-matching scores, or may use a learned ranking model. The server outputs an ordered list of candidate education resource information, which the server encapsulates as learning path information, including identifiers, order, and optional prerequisite relationships. The server saves this learning path information in the progress information storage apparatus, associated with the user identifier.

The server also uses the generative AI model to generate explanation text information and additional refinements of the learning path. The server constructs a prompt sentence that includes an explicit instruction section, a context section describing the user attributes derived from the natural language processing learning model, and a resource list section describing candidate education resources. An example of such a prompt sentence is:

“The user's goal is: ‘I want to learn data science.’

The user is a complete beginner in programming.

You are an educational assistant.

Given this ordered list of courses:

1. Python Basics for Data Science—an introductory Python course.

2. Introduction to Statistics—covers probability and basic statistics.

3. Machine Learning Fundamentals—basic ML algorithms and practice.

Explain to the user, in concise English, why this sequence is appropriate and what they will gain from each course.”

The server encodes this prompt sentence as a token sequence, and the server inputs the sequence into the generative AI model. The generative AI model processes the prompt using masked self-attention, computes attention weights between tokens that represent instructions, user attributes, and resource descriptions, and generates output tokens that form an explanation text. The server can apply a decoding algorithm such as greedy search, beam search, or top-k sampling with temperature control to obtain high-quality, coherent text. The server may apply output post-processing, such as length limitation, removal of undesired patterns, and formatting adjustments. The server transmits the resulting explanation text along with the learning path information to the terminal.

The user, by viewing the terminal display, receives both the ordered resource list and a textual explanation that clarifies the reason for the recommended path. The user can thereby understand the relationship between their expressed goal, their inferred proficiency level, and the recommended sequence of learning materials, which improves user trust and engagement. The server further manages dynamic updates to the learning path based on learning execution status information. The server receives, from the terminal, notifications indicating lesson start, lesson completion, quiz results, and time spent on tasks. The server records these events in the progress information storage apparatus with timestamps and resource identifiers. The server aggregates these events to update completion percentages for each resource, to identify which resources are completed, and to derive performance indicators such as average quiz score or number of repeated attempts.

The server then applies update conditions to determine whether the learning path should be modified. For example, the server may include conditions that trigger insertion of remedial resources when scores fall below a threshold, conditions that unlock advanced resources when a prerequisite is completed with a high score, or conditions that re-order upcoming resources to better match observed user strengths and weaknesses. The server can encode such conditions and target modifications as update contents that are included in another prompt sentence directed to the generative AI model. An example of such a prompt sentence is:

“The user has completed ‘Python Basics for Data Science’ and scored 60% on the statistics quiz.

Recommend the next content item and briefly explain why, in a supportive tone.

Candidate options:
1. Review: Basic Probability
2. Introduction to Statistics-Practice Problems
3. Machine Learning Fundamentals

Answer in English in 3-4 sentences.”

The server passes progress information and current learning path information in structured textual form to the generative AI model via such a prompt. The generative AI model computes, for each candidate option, its compatibility with the user's progress context by attending to tokens that represent scores, completion states, and resource descriptions. The generative AI model then generates a recommendation decision and an associated explanation. The server interprets generated text that indicates which option should be taken next, and the server applies an update operation to the stored learning path information to reflect the new recommended next resource. The server then transmits the updated path and explanation text to the terminal.

By implementing this architecture, the server improves computer technology beyond mere automation of human decision making. The server uses the natural language processing learning model and the generative AI model as programmable components driven by structured prompt sentences that encode decision criteria, attribute values, and contextual information. The server reduces the amount of rigid, hard-coded rule logic that would otherwise be required to interpret goal text, rank resources, and adapt paths. Instead, the server shifts part of the decision complexity into the models, which are optimized for high-dimensional representation and inference. This design leads to improved scalability, because the server can add new domains, attributes, and nuanced decision patterns by modifying prompt design and training data, without deep modification of underlying control code. The server achieves improved processing efficiency and accuracy by using representation vectors computed by the natural language processing learning model for similarity-based indexing and retrieval. The server stores these representation vectors in a vector index that supports efficient nearest neighbor search, which reduces database search time as compared to naive keyword matching or exhaustive scanning. The server also reduces communication load by sending compact identifiers and summarized attributes between components, rather than full raw Content, and by performing heavy computation on the server side where specialized hardware such as graphics processing units or tensor processing units may be installed.

The server, by integrating progress information into both traditional algorithmic processing and generative AI reasoning, creates a feedback loop that is not feasible with static rule sets. The generative AI model can jointly consider multi-dimensional attributes such as domain, level, skill, time constraints, and performance metrics when generating explanations and recommendations. The server, by expressing these factors in carefully constructed prompt sentences, ensures that the generative AI model performs a form of context-aware combinatorial reasoning that departs from simple human heuristics. In particular, the generated decisions can be conditioned simultaneously on representation vectors, category labels, and explicitly encoded update conditions, enabling decision patterns that are structurally complex and tuned for computational efficiency.

In another embodiment, the server employs alternative neural network architectures, such as recurrent neural networks or convolutional neural networks, for the natural language processing learning model, and employs different configuration of layers or hyperparameters. The server may change the dimensionality of representation vectors, the number of attention heads, or the number of layers to balance accuracy and latency. The server may also apply quantization or pruning techniques to reduce model size and increase inference throughput, thereby further improving processing efficiency of the learning support system.

In a further embodiment, the server uses different types of generative AI models, such as encoder-decoder architectures, and uses task-specific decoding strategies. For example, the server may constrain generation using a constrained decoding algorithm such that resource identifiers or decision labels are drawn from a specified set, and explanatory text is generated around these fixed choices. The server may thereby reduce error rates and increase reliability of decision interpretation while still benefiting from the expressive capability of the generative AI model.

In another variation, the terminal can be implemented as a wearable device such as smart glasses. The terminal in this case displays recommendations and explanations as augmented-reality overlays and receives user input via voice commands. The server remains responsible for heavy computation, and the overall system configuration continues to follow the same data structures, attribute extraction, prompt construction, and generative reasoning flow as described above.

Through these embodiments and variations, the server, the terminal, and the described models cooperate to implement a concrete technical solution that improves how computer systems interpret and act upon natural language learning goals. The server's use of specific data structures for representation vectors, progress records, and learning path graphs, and the server's use of non-conventional prompt-driven integration of deterministic algorithms with generative reasoning, produce measurable benefits such as higher recommendation precision, reduced computation time for relevant resource retrieval, and flexible adaptation of system behavior without extensive code changes.

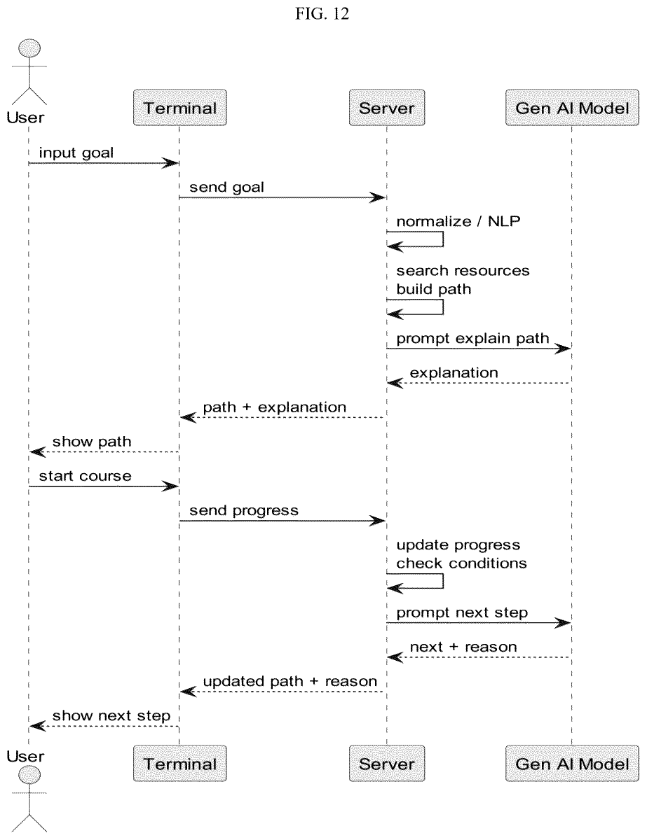

The following describes the processing flow using FIG. 12.

### Step 1:

The terminal displays a user interface for goal input and sends the goal to the server.

The terminal presents an input field and guidance text such as “Please enter what you want to learn (e.g., ‘I want to learn data science’).”

The user inputs a natural language goal sentence through a keyboard, touch interface, or voice-to-text interface on the terminal.

The terminal takes the raw input text and a stored user identifier as input data, checks that the text is non-empty and within a permitted length range, and discards invalid characters.

The terminal generates, as output data, a structured message including at least the user identifier, the goal text, and device metadata, and the terminal transmits this message to the server over a secure network connection.

### Step 2:

The server receives and normalizes the goal text.

The server accepts, as input, the structured message from the terminal containing the goal text and the user identifier via a network interface.

The server decodes the message format, extracts the goal text, and converts the text to a unified character encoding and Unicode normalization form.

The server applies lowercasing (when appropriate), trims leading and trailing whitespace, and removes control characters, thereby performing data cleaning operations on the string.

The server outputs a normalized analysis target string and stores the normalized string in a storage subsystem in association with the user identifier.

### Step 3:

The server tokenizes the analysis target string and generates numerical input for a natural language processing learning model.

The server receives, as input, the analysis target string produced in Step 2.

The server uses a tokenizer component of the natural language processing learning model to segment the string into tokens and map each token to a token identifier.

The server generates additional numerical arrays such as attention masks and token type identifiers, thereby converting the variable-length string into fixed-format numerical tensors. The server outputs the token identifiers and masks as a tensor data structure suitable for input to the neural network.

### Step 4:

The server applies the natural language processing learning model to extract attributes and representation vectors.

The server receives, as input, the token identifiers and attention masks from Step 3.

The server loads model parameters into memory and performs a forward pass through the neural network layers, including embedding, self-attention, and feed-forward operations. The server computes hidden-state vectors for each token and then applies a pooling operation, such as taking the hidden state of a special classification token or averaging all token states, to generate a fixed-length representation vector for the goal.

The server passes the pooled vector through a classification head that applies linear transformations and softmax functions to compute probability distributions over learning domain categories, proficiency levels, and skill types.

The server outputs, as structured data, a representation vector and attribute probabilities, and the server derives selected attributes (e.g., learning domain, proficiency, related skills) by applying thresholding or top-k selection to the probability distributions.

### Step 5:

The server constructs search conditions and retrieves candidate education resources from storage.

The server receives, as input, the selected attributes and representation vector from Step 4.

The server builds search conditions including the learning domain attribute, a permitted proficiency range, language preferences, and any necessary prerequisite tags.

The server submits these conditions as query parameters to an information storage apparatus that maintains education resource records and, where available, precomputed representation vectors for those resources.

The server computes similarity scores between the user's representation vector and stored resource vectors using a metric such as cosine similarity, and filters resources that do not satisfy the attribute-based conditions.

The server outputs, as a result, a list of candidate education resource information including resource identifiers, textual metadata, and similarity scores.

### Step 6:

The server ranks the candidate resources and constructs initial learning path information.

The server receives, as input, the candidate education resource list and associated similarity scores from Step 5.

The server applies a ranking algorithm that combines similarity scores with rule-based scoring or additional learned scoring functions, for example favoring introductory resources when the proficiency attribute indicates a beginner level.

The server sorts the candidates according to the resulting composite score and selects a subset as initial recommendations.

The server arranges the selected resources into an ordered sequence by considering prerequisite relations and logical learning progression, thereby constructing learning path information.

The server outputs the learning path information as a data structure containing resource identifiers, sequence positions, and optional dependency links.

### Step 7:

The server generates a prompt sentence for the generative AI model to explain and refine the learning path.

The server receives, as input, the learning path information, the selected attributes, and the original analysis target string.

The server combines these elements into a structured natural language prompt sentence that specifies an instruction, user context, and resource list.

The server, for example, composes a prompt sentence such as:

“The user's goal is: ‘I want to learn data science.’

The user is a complete beginner in programming.

You are an educational assistant.

Given this ordered list of courses:

1. Python Basics for Data Science—an introductory Python course.

2. Introduction to Statistics—covers probability and basic statistics.

3. Machine Learning Fundamentals—basic ML algorithms and practice.

Explain to the user, in concise English, why this sequence is appropriate and what they will gain from each course.”

The server outputs the constructed prompt sentence as a text sequence to be used as input to the generative AI model.

### Step 8:

The server invokes the generative AI model to generate explanation text.

The server receives, as input, the prompt sentence from Step 7.

The server tokenizes the prompt sentence and feeds the resulting token sequence into the generative AI model's embedding and masked self-attention layers.

The server computes output token probabilities iteratively, using an auto-regressive decoding strategy such as greedy decoding or beam search, thereby generating new tokens one by one. The server concatenates generated tokens into an explanation text and may truncate the text if it exceeds a specified token limit.

The server outputs the explanation text information, which provides natural language reasons for the recommended learning path.

### Step 9:

The server sends the learning path information and explanation text to the terminal.

The server receives, as input, the learning path information from Step 6 and the explanation text information from Step 8.

The server packages these data into a response message that includes ordered resource descriptions and the associated explanations.

The server transmits the response message via the network interface to the terminal associated with the user identifier.

The server outputs, as a result of this step, a complete recommendation payload that is delivered to the terminal for display.

### Step 10:

The terminal receives and displays the recommended learning path and explanation.

The terminal accepts, as input, the response message sent by the server in Step 9.

The terminal parses the message, extracts the ordered list of resources and the explanation text, and constructs data objects for display.

The terminal renders a graphical interface that lists the recommended resources in order, shows titles and short descriptions, and presents the explanation text as an accompanying narrative.

The terminal outputs, as a result, a visual representation of the learning path and explanatory information for the user.

### Step 11:

The user starts learning activities, and the terminal records learning execution status information.

The user selects one of the recommended education resources on the terminal interface, such as “Python Basics for Data Science,” and starts viewing lessons or performing exercises.

The terminal receives, as input, user actions such as play, pause, complete, and quiz answer submissions.

The terminal converts these actions into structured learning execution status events that include identifiers for the resource and lesson, timestamps, and outcome values such as quiz scores.

The terminal outputs these events as progress messages and transmits them periodically or upon completion of activities to the server.

### Step 12:

The server stores learning execution status information and updates progress data.

The server receives, as input, the progress messages from the terminal in Step 11.

The server validates the messages against stored user and resource identifiers and then writes the events into a progress information storage apparatus with indexes by user identifier and resource identifier.

The server aggregates newly received events with existing progress records by updating fields such as completion flags, last accessed timestamps, accumulated time spent, and average quiz scores.

The server outputs updated progress information, which reflects the current status of each education resource for the user.

### Step 13:

The server determines whether to update the learning path based on progress information.

The server receives, as input, the updated progress information and the current learning path information.

The server identifies which resources in the learning path are completed or uncompleted by comparing completion flags and completion thresholds.

The server evaluates predefined update conditions, such as score thresholds or completion of prerequisites, to decide whether resources should be reordered, whether remedial resources should be inserted, or whether advanced resources should be unlocked.

The server outputs a decision indicating whether the learning path remains unchanged or requires an update, along with specific update contents if a change is needed.

### Step 14:

The server generates a prompt sentence for the generative AI model to recommend the next resource and explain the update.

The server receives, as input, the decision and update contents from Step 13, the progress information, and candidate next resources.

The server incorporates this information into a context-rich prompt sentence that instructs the generative AI model to choose an appropriate next resource and generate a rationale.

The server, for example, constructs a prompt sentence such as:

“The user has completed ‘Python Basics for Data Science’ and scored 60% on the statistics quiz.

Recommend the next content item and briefly explain why, in a supportive tone.

Candidate options:
1. Review: Basic Probability
2. Introduction to Statistics-Practice Problems
3. Machine Learning Fundamentals

Answer in English in 3-4 sentences.”

The server outputs this prompt sentence as textual input for the generative AI model.

### Step 15:

The server applies the generative AI model to generate update explanation information and select the next resource.

The server receives, as input, the prompt sentence from Step 14.

The server tokenizes the prompt, processes the tokens through the generative AI model, and computes token probabilities for possible next tokens representing decisions and explanations.

The server executes a decoding strategy that both identifies which candidate resource is recommended and generates natural language that justifies the recommendation in view of the scores and completion states encoded in the prompt.

The server parses the generated output to extract the chosen resource identifier or label, and the server obtains the explanation sentences as update explanation information.

The server outputs an updated learning path that reflects the chosen next resource and accompanying explanation text.

### Step 16:

The server transmits the updated learning path and update explanation information to the terminal.

The server receives, as input, the updated learning path and update explanation information from Step 15.

The server builds a response message that includes indicators of which resources are completed, which resource is next, and the explanation of why the next resource was chosen.

The server sends this response message to the terminal over the communication network.

The server outputs, as a result, updated guidance data by which the terminal can present the new learning sequence to the user.

### Step 17:

The terminal updates the display based on the new learning path and explanation.

The terminal receives, as input, the response message containing the updated learning path and update explanation from Step 16.

The terminal revises its internal representation of the learning path, marks completed resources as finished, and highlights the newly recommended next resource.

The terminal displays the update explanation information in the user interface, so that the user can understand the reason for the change in sequence.

The terminal outputs an updated visual learning path and explanation, enabling the user to continue learning with dynamically adapted recommendations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems typically rely on static rule sets or manually designed recommendation logic to interpret user input and to construct learning paths. In such systems, a processor generally performs simple keyword matching or fixed-form questionnaire processing on text input from a user, and then selects learning materials from a predefined list. As a result, these systems have several technical limitations.

First, conventional systems have limited capability to convert unstructured, free-form natural language input into rich, machine-usable representations. The processor often handles only shallow parsing, which prevents accurate identification of a user's learning purpose, capability level, and target field from diverse textual expressions. This leads to low-quality internal state representations and degrades the performance of downstream computation, such as course selection and path planning.

Second, conventional systems usually treat recommendation logic as a one-shot process that is executed only at initial goal setting. The processor does not effectively integrate fine-grained learning execution result information and time-series learning progress information into a single model of the user. Consequently, the system cannot dynamically reconstruct learning paths in response to changing user performance, such as insufficient achievement in a particular module, unexpectedly rapid progress, or a shift in the user's long-term goal. The internal data structures for representing recommended paths remain essentially static and cannot be adaptively reconfigured in real time.

Third, even when a generative AI model is used, conventional approaches typically limit the model to directly outputting recommendations or explanations in an ad hoc manner. In such architectures, the processor performs little or no explicit control over prompt design, internal data abstraction, or mapping to higher-level concept taxonomies. This causes several technical problems: (i) the system cannot consistently obtain structured output suitable for storage, indexing, and recomputation; (ii) the processor cannot reliably combine model output with existing database structures and prerequisite graphs; and (iii) the use of computational resources is inefficient, because the model is repeatedly asked to solve similar tasks without leveraging prior structured results.

Fourth, existing systems often lack a robust mechanism for redefinition and reclassification of learning goals over time. Once an initial goal is set, there is inadequate technical support for updating that goal on the basis of accumulated history information, including both past natural language inputs and detailed learning progress metrics. As a consequence, the representation of the user's objective in memory becomes stale, and the system cannot realign internal recommendation logic with the user's evolved needs, leading to suboptimal use of storage, network, and processing resources.

Therefore, there is a need for an improved computer-implemented system and server architecture in which a processor systematically uses generative AI models via carefully constructed prompt sentences, converts unstructured character information into structured, higher-level concept categories, and integrates such structured data with stored educational content metadata and prerequisite information. In particular, there is a need for a processor that can aggregate learning execution result information, compute learning progress information, and dynamically update an internal recommended learning path data structure, thereby improving the technical functioning of the computer system itself, including data representation, retrieval efficiency, and adaptive control logic for personalizing learning content.

The specific processing by the specific processing unit 290 of the data processing device 12 in Example 2 is realized by the following means.

The present invention provides a server comprising a processor and a storage medium, the processor being configured to execute computer-readable instructions to (i) store character information acquired from a user terminal into the storage medium and construct inquiry information including the character information as a prompt sentence to be input to at least one generative AI model having a natural language processing function, (ii) cause the generative AI model to perform analysis processing based on the prompt sentence and acquire, as structured information, elements including a learning purpose, a capability level, and a target field contained in the character information, (iii) map the structured information to a classification scheme of higher-level concepts stored in the storage medium so as to determine a learning-goal category, (iv) retrieve, from the storage medium, a set of educational content associated with the learning-goal category and perform ordering of the set of educational content based on difficulty information and prerequisite relationship information stored in association with the educational content, (v) generate a second prompt sentence including at least the ordered set of educational content and the learning-goal category, input the second prompt sentence to the generative AI model, and cause the generative AI model to generate an explanatory text and a recommended learning path, (vi) store the recommended learning path in association with user identification information in the storage medium and transmit the recommended learning path and the explanatory text to the user terminal, (vii) acquire learning execution result information from the user terminal, aggregate the learning execution result information to calculate learning progress information, and generate a third prompt sentence including at least the learning execution result information and the learning progress information, (viii) input the third prompt sentence to the generative AI model so that the generative AI model specifies next educational content to be learned, and update in the storage medium the recommended learning path to include the next educational content, and (ix) in response to the learning progress information indicating that an achievement level of particular educational content does not satisfy a predetermined condition or that a difficulty level of particular educational content is excessive, generate a fourth prompt sentence to be input to the generative AI model for determining review content, supplementary content, or substitute content, and reconstruct the recommended learning path according to an output of the generative AI model. This enables the server to improve computer operation by systematically transforming unstructured natural language input into structured, higher-level concept representations, tightly integrating such representations with stored educational content and prerequisite metadata, and dynamically reconfiguring an internal recommended learning path data structure based on real-time learning progress, thereby enhancing the efficiency, adaptability, and technical performance of learning support processing executed by the computer system.

The term “system” refers to a combination of hardware and software components including at least one processor, at least one storage medium, and communication interfaces configured to execute the claimed processing.

The term “processor” refers to one or more hardware computation units, such as a central processing unit or an accelerator, configured to execute machine-readable instructions to perform logical operations, arithmetic operations, control operations, and data transfer operations described in the claims.

The term “storage medium” refers to any non-transitory computer-readable medium, such as a semiconductor memory, a magnetic storage device, or an optical storage device, configured to store data, metadata, program code, models, and classification schemes used by the processor.

The term “user terminal” refers to an electronic apparatus operated by a user, such as a general-purpose computer, a mobile communication device, or a tablet device, configured to transmit character information and learning execution result information to the server and to receive learning paths and explanatory texts from the server.

The term “character information” refers to information expressed as a sequence of characters, including natural language text input by a user, and representing at least a learning wish, a learning goal, or a related description.

The term “inquiry information” refers to data constructed by the processor that includes at least a portion of the character information and is formatted to be used as a prompt sentence for a generative AI model.

The term “prompt sentence” refers to a machine-readable string of characters including instructions, context, and user-related data, which is input to a generative AI model to cause the generative AI model to perform a specified analysis, generation, or decision-making task.

The term “generative AI model” refers to a machine learning model, such as a neural network-based language model, configured to receive a prompt sentence and to generate a text output including at least one of analysis results, structured information, explanatory text, or recommendations.

The term “natural language processing function” refers to a capability of a model or software component to analyze, interpret, transform, or generate human language expressions in text form.

The term “structured information” refers to data that is organized according to a predefined schema or format, such as a set of key-value pairs or a record, and that includes elements representing at least a learning purpose, a capability level, and a target field derived from the character information.

The term “learning purpose” refers to an intention or objective of a user's learning activity, represented in an abstracted form, such as acquiring a particular type of knowledge or skill.

The term “capability level” refers to an indication of a user's current or assumed proficiency in a subject area, expressed in one or more discrete levels, such as beginner, intermediate, or advanced.

The term “target field” refers to a subject area or domain to which the learning purpose is directed, such as a technical field, a professional skill area, or an academic discipline.

The term “classification scheme of higher-level concepts” refers to a taxonomy, ontology, or hierarchical classification stored in the storage medium, in which learning-related concepts are organized into categories that represent generalized or abstracted groupings.

The term “learning-goal category” refers to a category within the classification scheme of higher-level concepts, determined by the processor based on the structured information, and representing a generalized classification of the user's learning goal.

The term “educational content” refers to any digital instructional material stored or referenced by the system, such as course data, lesson data, assessment data, or explanatory materials, which can be presented to the user for learning.

The term “set of educational content” refers to a collection of one or more educational content items selected or retrieved based on at least the learning-goal category.

The term “difficulty information” refers to metadata associated with educational content that indicates the relative complexity, prerequisite knowledge, or expected skill level required for effective learning of that content.

The term “prerequisite relationship information” refers to metadata representing dependency relations among educational content items, indicating which content should be completed before another content to maintain a coherent learning sequence.

The term “explanatory text” refers to natural language text generated by the generative AI model or by the processor, which explains or describes at least a learning path, educational content, or a recommendation rationale to the user.

The term “recommended learning path” refers to an ordered sequence or structure of educational content items generated and stored by the processor, representing a suggested learning progression for a particular user.

The term “user identification information” refers to data used to uniquely or pseudo-uniquely identify a user in the system, such as an identifier, an account name, or a token.

The term “learning execution result information” refers to data indicating outcomes of a user's interaction with educational content, including at least completion status, performance scores, timestamps, or time spent.

The term “learning progress information” refers to data derived from aggregation or computation over learning execution result information, representing the current state of a user's progress in one or more educational content items or learning paths.

The term “next educational content to be learned” refers to at least one educational content item determined by the system, based on the learning progress information and the learning-goal category, as a subsequent learning step for the user.

The term “achievement level” refers to a quantitative or qualitative measure, derived from learning execution result information, that indicates the extent to which a user has successfully learned particular educational content.

The term “predetermined condition” refers to a condition or threshold, stored in the storage medium, against which the achievement level or difficulty level is evaluated to decide whether to add review, supplementary, or substitute content.

The term “review content” refers to educational content intended to reinforce or revisit topics that a user has not sufficiently mastered according to the achievement level.

The term “supplementary content” refers to educational content provided in addition to main content, and intended to support understanding when user performance indicates a need for additional explanation or practice.

The term “substitute content” refers to educational content selected to replace other educational content whose difficulty level is determined to be excessive or otherwise unsuitable for the user.

The term “reconstruct the recommended learning path” refers to an operation by which the processor modifies the stored recommended learning path, including at least inserting, removing, or reordering educational content items based on output from the generative AI model and current progress data.

The term “history information” refers to accumulated data associated with a user, including past character information, past structured information, learning execution result information, and learning progress information, which can be used to redefine or reclassify learning goals.

The term “redefining a learning goal” refers to updating or replacing an existing representation of the user's learning purpose based on history information and output from the generative AI model.

The term “reclassifying the learning-goal category” refers to assigning a new or modified learning-goal category within the classification scheme of higher-level concepts, in accordance with updated analysis results produced by the generative AI model.

In one embodiment, a server cooperates with a plurality of user terminals to implement an adaptive learning support system as defined in the claims. The server includes at least one processor, at least one storage medium, and a communication interface connected via a network to the terminals. The processor executes machine-readable instructions stored in the storage medium to perform the operations described below.

The server uses general-purpose computing hardware to implement the processor, such as a central processing unit and one or more accelerator units. The accelerator units include, for example, a graphics processing unit configured to execute large-scale matrix operations for neural network inference. The storage medium includes a main memory, such as a dynamic random-access memory, and a non-volatile memory, such as a solid-state drive, storing program code, model parameters, and data structures. The server executes server-side application software implemented using, for example, a web application framework and a machine learning library. In one example, the server runs a runtime environment such as a high-level programming language interpreter together with a numerical computation library that supports tensor operations.

The server stores, in the storage medium, data structures including at least: (i) a user profile table, (ii) a raw character information table, (iii) a structured information table, (iv) a classification scheme table representing higher-level learning-goal categories, (v) an educational content table, (vi) a prerequisite relationship table, (vii) a recommended learning path table, and (viii) a learning execution result table. Each table is implemented as a record-oriented data structure, such as a relational table or a key-value store, with indices on fields including user identifiers, category codes, and content identifiers. The server thereby enables efficient retrieval and update of learning-related information by indexed queries, reducing access latency and improving scalability compared to unstructured storage.

The server implements a generative AI model as a language model executed on the aforementioned hardware. In one embodiment, the generative AI model is a transformer-based neural network having multiple self-attention layers, feedforward layers, and layer normalization layers. The model receives as input a sequence of tokens representing a prompt sentence and outputs a probability distribution over tokens for each position. The server stores, in the storage medium, model parameters including weight matrices for attention (query, key, value matrices), weight matrices for feedforward layers, and embedding vectors for tokens and positional encodings. The model is pre-trained on a large corpus of text using a self-supervised learning method and may be fine-tuned on domain-specific learning content.

The server trains the generative AI model, in an offline process, by minimizing a loss function such as a cross-entropy loss between predicted token distributions and ground-truth tokens. The server updates the weight parameters using an optimization algorithm such as stochastic gradient descent with adaptive learning rates. The server applies backpropagation through time over token sequences and uses gradient clipping and regularization methods to stabilize learning. The server optionally applies data augmentation techniques including random masking of input tokens and shuffling of context segments to improve generalization. These training operations are not necessarily performed on the same device as the inference server, but the resulting trained weights are loaded into the server's memory at runtime for inference.

The server uses the generative AI model in inference mode to transform natural language input into structured, higher-level representations. The server constructs a prompt sentence that includes explicit instructions, formatting constraints, and the user's character information. For example, the server generates the following prompt sentence for goal extraction:

“You are an assistant that identifies learning goals from user input.

User input: ‘I want to learn programming from scratch so that I can build simple applications.’

Extract the main learning goal, the skill level (beginner, intermediate, or advanced), and the target field.

Return the result as JSON-like text with keys goal, skill_level, and domain.”

The server tokenizes this prompt sentence into integer token identifiers using a tokenizer consistent with the generative AI model's vocabulary, then forms tensors representing token sequences and positional indices. The server transfers these tensors to the accelerator memory and executes the transformer layers in sequence. The internal attention mechanism computes, for each layer, attention scores by multiplying query and key matrices and applying a softmax function. The feedforward network applies nonlinear activation functions such as rectified linear units or Gaussian error linear units. The server obtains the output token probabilities and decodes them to form a textual response.

The server parses the textual response to extract structured fields such as “goal: learn basic programming,” “skill_level: beginner,” and “domain: programming.” The server converts these textual fields into internal codes by mapping them to entries in the classification scheme table. For example, a domain field “programming” is mapped to a higher-level category such as “computational skills,” and a capability level “beginner” is mapped to an internal level code. This mapping is implemented by a lookup function referencing a taxonomy stored in the storage medium. As a result, the server transforms unstructured, user-specific expressions into normalized, machine-usable category codes that can be indexed and reused.

The server thereby improves data management in that it maintains a clear separation between free-form character information and structured category codes. The server maintains stable keys for learning-goal categories that can be used to efficiently query associated educational content. Because the mapping step reduces variability in text expressions and consolidates semantically similar intentions into common categories, the server enables more accurate and faster retrieval of relevant content from large educational content datasets.

The server stores educational content metadata in the educational content table. Each record contains at least a content identifier, a category code, a difficulty score, and one or more prerequisite content identifiers. The server stores prerequisite relationships as directed edges in a graph structure represented either as adjacency lists or as a separate prerequisite relationship table. The server uses this graph structure to determine valid sequences of content. For example, the server enforces that introductory content must be completed before intermediate content when generating a recommended path.

The server selects content based on the learning-goal category by performing an indexed query on the educational content table to obtain candidate content items. The server orders the candidate items using an ordering algorithm that considers difficulty information and prerequisite relationships. In one implementation, the server performs a topological sort of the prerequisite graph restricted to the candidate items, and within each level of the sort, the server orders items by increasing difficulty. This algorithm ensures that the resulting sequence respects prerequisite constraints while gradually increasing complexity. This ordering contributes to technical improvement because it is executed as a graph-processing algorithm on indexed records, which can be optimized for low computational complexity and predictable performance.

The server uses the generative AI model not only for goal extraction but also for path explanation and refinement. The server constructs a prompt sentence that summarizes the ordered set of educational content and the learning-goal category, and instructs the model to propose a human-readable explanation and optionally to adjust the ordering within specified constraints. For example, the server may generate a prompt sentence such as:

“You are a curriculum planner.

The user's learning-goal category is ‘basic programming skills.’

Available content items are:
1) Introduction to Programming (very basic)
2) Programming Basics with a general-purpose language (beginner)
3) Fundamental Programming Logic (beginner)

Create an ordered learning path for a beginner and briefly explain why this order is appropriate.

Return the final order and the explanation in plain text.”

The server then uses the returned order to adjust the topologically sorted sequence, provided that prerequisite constraints are not violated. This hybrid approach combines deterministic graph algorithms with model-based refinement. The server thereby exploits the generative AI model's language understanding to optimize user-facing explanations and minor ordering decisions, while still relying on explicit graph computations for critical prerequisite constraints. This leads to higher quality learning paths without sacrificing reproducibility or computational efficiency.

The server maintains a recommended learning path data structure as an ordered list or sequence of content identifiers stored in the recommended learning path table, associated with a user identifier. When the server receives learning execution result information from a user terminal, such as completion flags, scores, or timestamps, the server updates the learning execution result table and derives updated learning progress information. The server computes aggregated metrics including completion percentage, average score, and time on task using aggregation functions and stores the results in the structured information table. The server then updates the recommended learning path by marking completed content and determining the next educational content to be learned.

The server uses a rule-based decision layer in conjunction with the generative AI model to handle dynamic path updates. The rule-based layer implements non-conventional control logic that regulates when the generative AI model is invoked. For example, the server only constructs a next-step prompt sentence when the user's progress satisfies certain conditions, such as completion of a prerequisite node or detection of low achievement in a particular content item. This design reduces unnecessary inference calls, thereby reducing computation load on the accelerator and communication overhead with any external AI service.

When the server determines that a user's achievement level for a given content item is below a threshold, the server generates a prompt sentence that includes quantitative performance metrics and the structure of surrounding content in the path. For example, the server may use: “The user has completed ‘Programming Basics’ with a quiz score of 45 out of 100 and repeated errors in loop constructs.

The user's learning-goal category is ‘basic programming skills.’

Propose review or supplementary content focusing on loop constructs and beginner-level problem solving, and indicate whether the main path should be delayed until after this review.

Return your recommendation and a brief rationale in plain text.”

The server interprets the response and modifies the recommended learning path by inserting review or supplementary content before the subsequent main content. Because this operation is based on numerical thresholds, structured graphs, and explicit insertion operations on an ordered list in memory, the changes are deterministic and auditable. The system thereby reduces error rates in user progression and increases the likelihood of mastery before advancement, which constitutes a technical effect on the behavior of the overall computing system rather than a mere change in educational policy.

The server achieves improved processing speed and scalability by implementing caching and reuse of structured information. Once the server converts a particular user's free-form text into a structured representation and a learning-goal category, the server can reuse this structure for repeated inference or recommendation cycles without re-running the full natural language analysis. The server stores intermediate results in the structured information table and checks them before constructing a new prompt sentence. If the existing structured information is still valid, the server bypasses the generative AI model and directly executes indexed queries and graph ordering algorithms. This reduces the number of heavy neural network inferences, thereby improving computational efficiency and lowering energy consumption.

The server further improves accuracy and robustness by designing prompt sentences in a constrained format that promotes machine-parseable, low-variance responses. The server includes explicit instructions regarding output format and allowed values, for example by asking the model to output specific labels for skill level. The server then validates the generated output against these constraints and, if necessary, applies correction logic. This interaction between explicit constraints and neural network inference reduces the chance of malformed or ambiguous responses, which in turn reduces the need for expensive error-handling routines downstream. The reduction in parsing errors is a direct improvement in the reliability of the computer system.

The server, in some embodiments, runs multiple generative AI models or multiple configurations of a model in parallel. The server may use a smaller, faster model for routine classification of skill levels and a larger, more expressive model for generating detailed explanations. The server coordinates these models via a controller module that decides, based on request type and current load, which model configuration to use. By selecting the smallest adequate model for each task, the server optimizes resource utilization and reduces inference latency, which is a technical improvement over a simple one-model-for-all approach.

The server differs from human manual processing in that it applies consistent, formalized mapping algorithms, graph-based path construction, and structured data storage combined with neural network inference. A human might read a user's goal, select materials, and adapt a plan in a subjective and non-repeatable manner, but the server performs repeatable operations governed by explicit rules and trained parameters. The server's integration of token-level neural computation, indexed database queries, and graph traversal algorithms creates a composite processing pipeline that cannot be implemented by mere human mental steps at scale or speed.

The terminal operates as a client device with a user interface to present learning goals, recommended paths, and explanations. The terminal executes a browser or native application that renders lists, progress bars, and textual explanations based on data received from the server. The terminal transmits user input as character information and sends learning execution result information when the user completes a content item, achieves a score, or spends a certain duration on a lesson. The terminal thereby acts as a sensor for learning activity, feeding event-level data back to the server's processing pipeline.

The user interacts with the terminal to provide natural language descriptions of learning intentions and to follow the recommended learning path. The user can, for example, type “I want to use a particular programming language for data analysis” in an input field. The user can view the resulting path, which may be described to the user as: “First learn general programming concepts, then take an introductory course in the language, and finally take an intermediate course on data analysis.” This interaction closes the loop between human learning behavior and the server's adaptive algorithmic control.

In an alternative embodiment, the server uses a different neural network architecture, such as a sequence-to-sequence recurrent neural network with attention. In this case, the server still constructs prompt sentences as input sequences and uses the network to produce output sequences. The internal computations differ in that recurrent units such as long short-term memory cells propagate state information across tokens. Nevertheless, the same data structures, classification mappings, and graph ordering mechanisms are applied. This variation demonstrates that the invention is not limited to a particular neural network implementation but rather to the coordinated use of generative AI models, structured mappings, and dynamic path management.

In another embodiment, the server precomputes learning-goal categories and recommended starting paths for common intent patterns. The server maintains a cache of standard prompt sentences and corresponding model outputs for typical input phrases. When a new user's character information closely matches one of these patterns, the server retrieves the cached structured information and path instead of invoking the generative AI model. The server may still refine the path using the model later based on user-specific progress. This approach reduces initial response time and further decreases computational load, representing a technical optimization of system performance.

In yet another embodiment, the server compresses stored recommended learning paths and structured information using a data compression algorithm and organizes them in a manner optimized for fast retrieval by user identifier and category. This reduces storage requirements and input/output operations on the storage medium. Because the server distinguishes between frequently accessed fields (such as current next-step content) and archival fields (such as historical path versions), the server can place data in different storage tiers, further improving access time for active users and reducing overall system latency.

Through these embodiments, the server uses specific hardware resources, concrete neural network architectures, explicit data structures, and non-conventional control logic to implement an adaptive learning path generation and update mechanism. The combination of generative AI model inference, structured category mapping, graph-based ordering, and progress-dependent dynamic reconstruction yields improvements in accuracy of goal interpretation, efficiency of content retrieval, and responsiveness of path adaptation. These improvements are realized as measurable enhancements to the operation of the computer system itself, in terms of processing speed, memory usage, communication load, and error rates, and therefore extend beyond a mere automation of human teaching or administrative tasks.

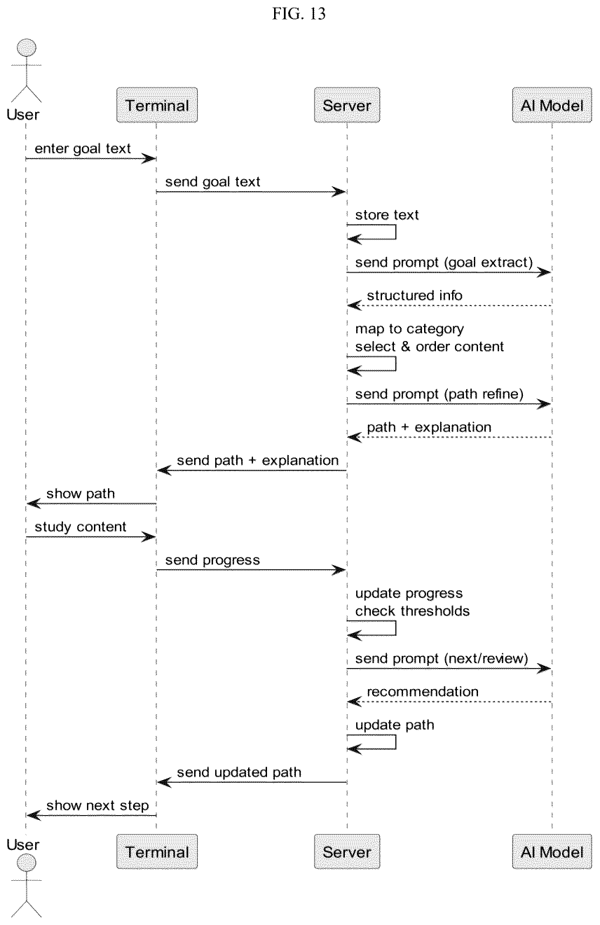

The following describes the processing flow using FIG. 13.

### Step 1:

User operates the terminal to input a learning request.

User opens an application or web page on the terminal and types free-form character information, such as “I want to learn programming from scratch so that I can do data analysis.”

User presses a send or submit button.

Input: natural-language text entered by the user.

Output: a text string displayed in an input field on the terminal and prepared for transmission.

### Step 2:

Terminal transmits the character information to the server.

Terminal packages the text string together with user identification information and a timestamp into a request payload.

Terminal sends the payload to the server via a network using a communication protocol such as HTTPS.

Input: the text string and user identification information.

Output: a network request message containing the character information, delivered to the server.

### Step 3:

Server receives and stores the raw character information.

Server accepts the network request through a server application and validates the format and authentication information.

Server writes the character information, the user identification information, and the timestamp into a storage medium as a new record in a raw input table.

Input: the network request message containing character information and user identification information.

Output: a stored record in the storage medium representing the raw user input.

### Step 4:

Server constructs a first prompt sentence for goal extraction.

Server reads the stored character information from the raw input table or from the received request object in memory.

Server inserts the character information into a predefined template that instructs a generative AI model to identify a learning goal, a capability level, and a target field.

Server concatenates instruction text, formatting constraints, and the user text to form a single prompt sentence, for example:

“You are an assistant that identifies learning goals from user input. User input: ‘I want to learn programming from scratch so that I can do data analysis.’ Extract the main learning goal, the skill level (beginner, intermediate, or advanced), and the target field. Return the result in a structured text format.”

Input: the raw character information and a stored prompt template.

Output: a complete prompt sentence suitable for input to a generative AI model.

### Step 5:

Server performs natural language analysis using the generative AI model.

Server tokenizes the prompt sentence into tokens using a tokenizer compatible with the generative AI model.

Server encodes the tokens into numerical identifiers and forms input tensors representing the sequence.

Server forwards the tensors through the layers of a neural network model, where matrix multiplications, attention weight calculations, and nonlinear activations are executed on a processor and optionally an accelerator.

Server decodes the resulting output token probabilities into a text response that includes structured information such as a learning goal, a skill level, and a target field.

Input: the prompt sentence created by the server.

Output: a generated text response containing structured information in textual form.

### Step 6:

Server parses the generated response into structured information.

Server analyzes the generated text using parsing rules to extract fields such as “goal,” “skill_level,” and “domain.”

Server converts these fields into an internal structured representation, for example a record with named attributes.

Server stores this structured representation in a structured information table in the storage medium.

Input: the generated text response produced by the generative AI model.

Output: a structured information record representing the learning purpose, capability level, and target field.

### Step 7:

Server maps the structured information to higher-level learning-goal categories.

Server reads the structured information record and obtains the goal, skill level, and target field values.

Server compares these values with entries in a classification scheme stored in a classification table, using lookup and matching operations.

Server determines a learning-goal category code that corresponds to the combination of goal, skill level, and target field, and stores this category code in association with the user.

Input: the structured information record with goal, skill level, and target field.

Output: a learning-goal category code stored in the storage medium.

### Step 8:

Server selects an initial set of educational content based on the learning-goal category.

Server queries an educational content table using the learning-goal category code as a key or filter condition.

Server retrieves content items whose metadata indicates a match to the category and capability level, such as beginner-level content for a beginner category.

Server assembles these content items into a content candidate set and stores or holds this set in memory.

Input: the learning-goal category code and the content metadata stored in the educational content table.

Output: a content candidate set related to the determined learning goal.

### Step 9:

Server orders the content candidate set using difficulty and prerequisite relationships.

Server retrieves difficulty scores and prerequisite relationship entries for each content item from the storage medium.

Server constructs a graph or list structure that represents prerequisite dependencies among the content items.

Server applies a graph ordering algorithm, such as a topological sort, and then uses difficulty scores to refine the order, so that basic items precede more difficult items.

Input: the content candidate set, difficulty information, and prerequisite relationship information.

Output: an ordered list of educational content items representing a preliminary learning path.

### Step 10:

Server constructs a second prompt sentence for learning path explanation and refinement.

Server summarizes the ordered list of content items and the learning-goal category in natural language.

Server embeds this summary into a template that instructs the generative AI model to refine the path and generate an explanation, for example:

“You are a curriculum planner. The user's learning-goal category is ‘basic programming skills.’ The current ordered content items are: 1) Introduction to Programming, 2) Programming Basics, 3) Fundamental Programming Logic. Review this order and, if needed, adjust it while keeping prerequisite relations. Explain briefly why the final order is appropriate.”

Server creates a final prompt sentence including the list and instructions.

Input: the ordered list of educational content items and the learning-goal category.

Output: a second prompt sentence for learning path refinement and explanation.

### Step 11:

Server refines the learning path and generates explanatory text using the generative AI model.

Server provides the second prompt sentence to the generative AI model and initiates an inference.

Server processes the returned text, which may include a revised order and an explanation, and parses it to obtain a refined sequence of content items.

Server ensures that the refined sequence does not violate prerequisite relationships by checking against the prerequisite graph.

Server stores the refined sequence as a recommended learning path and separately stores the explanatory text.

Input: the second prompt sentence and the model's output text.

Output: a refined recommended learning path and an associated explanatory text.

### Step 12:

Server stores and associates the recommended learning path with the user.

Server creates or updates a record in the recommended learning path table that includes the user identification information and the ordered list of content identifiers.

Server stores the explanatory text in association with the recommended learning path, enabling later retrieval for display.

Input: the refined recommended learning path and user identification information.

Output: a persistent record of the recommended learning path and explanation in the storage medium.

### Step 13:

Server transmits the recommended learning path and explanation to the terminal.

Server formats the learning path and explanatory text into a response payload that the terminal can interpret.

Server sends the payload over the network to the terminal.

Input: the stored recommended learning path and explanatory text.

Output: a network response containing the learning path and explanation, delivered to the terminal.

### Step 14:

Terminal displays the recommended learning path and explanation to the user.

Terminal receives the response from the server and parses the learning path and explanatory text.

Terminal renders a user interface showing the sequence of educational content items, their titles, and the explanation describing why this order is appropriate.

Input: the response payload from the server.

Output: a visual or interactive display presented to the user on the terminal.

### Step 15:

User follows the recommended learning path and generates learning execution results.

User selects a recommended content item on the terminal, such as an introductory course, and consumes the material.

User completes assessments or exercises, and the terminal measures completion status and scores.

Input: the displayed learning path and educational content.

Output: user actions that result in completion data, scores, and timestamps.

### Step 16:

Terminal transmits learning execution result information to the server.

Terminal observes events such as lesson completion or quiz submission and packages these events as learning execution result information.

Terminal sends this information to the server at defined points, such as when a module is completed or when a test is graded.

Input: user completion status, score information, and timing data.

Output: a network message containing learning execution result information for specific content items.

### Step 17:

Server stores and aggregates learning execution result information.

Server receives the execution result information and writes it into a learning execution result table in the storage medium, keyed by user identification and content identification.

Server periodically or upon each update calculates aggregated learning progress information, such as overall completion rate and average scores, using arithmetic operations and aggregation functions.

Input: learning execution result records from the terminal.

Output: updated learning execution result records and derived learning progress information for each user and content item.

### Step 18:

Server determines whether path modification is required based on achievement levels.

Server compares the learning progress information and performance metrics against thresholds stored in configuration data.

Server identifies content items for which user achievement is below or above predetermined conditions, such as low scores or rapid completion.

Server decides whether to maintain, enhance, or revise the recommended learning path.

Input: learning progress information, achievement thresholds, and the current recommended learning path.

Output: a decision result indicating whether to add review, supplementary, or substitute content, or to move to the next main content.

### Step 19:

Server constructs a third prompt sentence for next-step recommendation or remediation.

Server summarizes the user's achievement, recent content, and overall learning-goal category in text form.

Server creates a prompt sentence that requests a next educational content recommendation or a suggestion for review material, for example:

“The user has completed ‘Programming Basics’ with a score of 45 out of 100, with frequent errors in loop constructs. The user's learning-goal category is ‘basic programming skills.’ Recommend appropriate review or supplementary content focusing on loop constructs and indicate whether the user should proceed to the next main content or first study this review content.”

Input: learning progress information, achievement results, and the learning-goal category.

Output: a third prompt sentence tailored to the user's current status.

### Step 20:

Server invokes the generative AI model to obtain recommendations for path update.

Server submits the third prompt sentence to the generative AI model for inference.

Server receives the model output, which may specify a recommended next main content item, review content, or supplementary content, and may include a short rationale.

Server parses this output and converts any mentioned titles or topics to internal content identifiers using matching and lookup operations.

Input: the third prompt sentence.

Output: recommended content items and rationale information suitable for updating the learning path.

### Step 21:

Server updates the recommended learning path in the storage medium.

Server modifies the ordered list of content identifiers in the recommended learning path table by inserting, removing, or reordering items according to the parsed recommendations and internal rules.

Server preserves prerequisite constraints by checking the underlying prerequisite relationship information before applying changes.

Server writes the updated path and, optionally, an updated explanation into the storage medium.

Input: the current recommended learning path, the model's recommendations, and prerequisite relationship information.

Output: an updated recommended learning path that reflects the user's progress and needed remediation or advancement.

### Step 22:

Server transmits the updated recommended learning path to the terminal.

Server constructs a new response payload including the updated ordered list of content items and any revised explanatory text.

Server sends this payload over the network to the terminal.

Input: the updated recommended learning path and associated explanation.

Output: a network response conveying the updated learning guidance to the terminal.

### Step 23:

Terminal presents the updated guidance to the user and continues the learning cycle.

Terminal receives the updated path and explanation, parses the content identifiers, and updates the user interface to highlight completed items, current items, and newly recommended items.

Terminal displays any revised explanation that informs the user why the path was changed, such as the need for additional practice on specific concepts.

Input: the updated path and explanation from the server.

Output: a refreshed display that guides the user to the next recommended educational content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems typically apply static rule sets or fixed recommendation logic to select educational resources and construct learning paths. In such systems, a processor generally analyzes user input with predetermined natural language processing pipelines and then maps extracted keywords to preconfigured course lists. As a result, these systems suffer from several technical limitations.

First, the systems are not architected to leverage a generative AI model via dynamically generated prompt sentences as a core computation component for multi-stage tasks, such as learning-goal extraction, resource ranking, and path redesign. The processor usually applies a single, generic model call or a shallow text classification model, which leads to a rigid architecture that is difficult to adapt to diverse user intents and complex goal structures. This causes inefficient use of computing resources because downstream components must compensate with additional heuristic logic and repeated database queries.

Second, conventional systems generally treat user emotion, if considered at all, as an external parameter or a simple numeric value that is not tightly integrated into the computational pipeline of goal formation and path planning. Emotional state data are often stored but not used as a first-class input to the core decision logic that determines difficulty, sequencing, or constraint conditions. This results in a non-optimal internal data flow: progress data, emotion data, and model outputs are not normalized or jointly used to control subsequent processing. Consequently, when the user's emotional state changes during learning, the system typically cannot reconfigure the learning path in a timely and technically efficient manner; instead, it relies on infrequent batch updates or manual intervention, leading to stale or misaligned recommendations.

Third, existing architectures tend to couple learning-goal extraction, resource selection, and path generation into monolithic, application-specific code. Prompt construction for generative AI calls, when present, is often hard-coded for only one stage (e.g., goal extraction) and does not define a generalized mechanism for programmatically generating multiple types of prompt sentences driven by internal state (analysis results, emotion state, progress metrics). This monolithic design hinders scalability and makes it difficult to maintain consistency between different AI calls, causing increased processing latency and inconsistent outputs from the generative AI model.

Fourth, conventional systems do not provide a systematic framework in which the processor can repeatedly and automatically generate prompt sentences for the generative AI model to redesign or adjust an existing learning path based on newly received progress logs and emotional analysis. Many systems perform updates either by predefined rules without model assistance, or by ad-hoc model queries that are not linked to a structured representation of the learning path stored in a database. As a result, the path adjustment process is fragmented: the model output may not be directly mappable back to the internal path data structure, requiring additional translation steps and manual tuning, which degrades performance and robustness. Accordingly, there is a need for an improved computer-implemented system in which a processor systematically coordinates (i) natural language input from a user terminal, (ii) results from a generative AI model obtained via explicitly constructed prompt sentences, (iii) emotion estimation, and (iv) structured progress data, and in which this coordination is used to automatically generate, update, and store learning objectives, educational-resource selections, and learning paths. There is a need to improve the way a computing apparatus constructs prompt sentences, feeds structured resource lists and state information into a generative AI model, interprets the model responses, and updates internal data structures, so that the overall computer operation for personalized, emotion-aware learning path generation and adaptation becomes more efficient, modular, and technically robust.

The specific processing by the specific processing unit 290 of the data processing device 12 in Application Example 2 is realized by the following means.

The present invention provides a server comprising a processor configured to (i) receive natural language input data from a user terminal, (ii) automatically construct multiple types of prompt sentences to be supplied to a generative AI model, including a first prompt sentence that instructs the generative AI model to identify a learning objective from the natural language input, a second prompt sentence that instructs the generative AI model to perform natural language analysis of the input, and at least one further prompt sentence that supplies structured candidate educational-resource list data and requests selection or ranking of the resources, (iii) estimate an emotional state of a user by processing analysis results and additional user input, (iv) redefine the learning objective as objective information including at least a difficulty level and constraint conditions corresponding to the emotional state and the analysis results, (v) generate, based on the redefined objective information, database queries to an educational-resource data store and obtain structured candidate educational-resource data, (vi) generate and transmit to the generative AI model a prompt sentence including the structured candidate educational-resource data so that the generative AI model returns a recommendation of at least one educational resource, (vii) construct and store a learning path represented as structured data, the learning path including a plurality of learning steps each associated with at least one educational resource selected according to the recommendation, (viii) generate presentation data for causing the user terminal to present the learning path and explanation information, and (ix) repeatedly generate further prompt sentences for instructing the generative AI model to modify or redesign the stored learning path in response to learning progress information and additional natural language input from the user terminal and to dynamically update the structured representation of the learning path according to responses from the generative AI model. This enables the server to technically improve coordination between natural language processing, emotion estimation, and structured learning-path management within the computing system, by using dynamically generated prompt sentences as a standardized interface to the generative AI model, thereby enhancing efficiency, modularity, and responsiveness of computer resources for generating and adaptively updating personalized, emotion-aware learning paths.

The term “system” refers to a collection of one or more computing devices and associated components that cooperate to execute the functions described herein, including at least a server and optionally one or more user terminals and data stores.

The term “processor” refers to one or more hardware processing units, such as a central processing unit, graphics processing unit, or other programmable processing circuitry, configured to execute instructions that implement the functions described herein.

The term “user terminal” refers to an endpoint computing device operated by a user, such as a mobile device, a portable information processing device, or a stationary information processing device, that is capable of transmitting natural language input and receiving presentation data from the server.

The term “natural language input data” refers to information expressed in a human language, such as text or transcribed speech, received from the user and processed by the system.

The term “generative AI model” refers to a machine-learned inference model that generates output content, including text or structured data, in response to an input instruction or context, and that is used by the system to perform at least learning-goal extraction, natural language analysis, resource selection, or learning-path modification.

The term “prompt sentence” refers to a machine-readable instruction sequence or textual command provided to the generative AI model to specify a desired processing task and to supply contextual information, including at least user input data, analysis results, or educational-resource information.

The term “learning objective” refers to a representation of a target learning outcome for the user, including at least a learning field and a desired proficiency level.

The term “objective information” refers to structured data describing the learning objective, including at least a difficulty level, a learning field, and one or more constraint conditions.

The term “difficulty level” refers to an indicator representing a relative challenge of educational content or learning steps, such as beginner, intermediate, or advanced.

The term “constraint conditions” refers to one or more limitations or preferences that affect selection or sequencing of educational resources and learning steps, such as time limitations, preferred content style, prerequisite coverage, or emotional considerations.

The term “natural language analysis” refers to a processing operation that analyzes natural language input data, including at least tokenization, classification, or extraction of semantic or syntactic features.

The term “analysis result” refers to data produced by the generative AI model or another analysis component, describing at least extracted entities, topics, or attributes of the user's natural language input.

The term “emotional state” refers to an estimated psychological condition of the user, such as anxiety, fear, boredom, confidence, or related affective states, represented as one or more values or labels computed from user input or behavior.

The term “emotion estimation” refers to a processing operation that derives the emotional state of the user from input data, including at least natural language input, and that outputs a representation of the emotional state.

The term “educational resource database” refers to a structured data store that maintains records of educational content items, such as courses, lessons, assessments, or instructional materials, each associated with metadata including at least a topic and a difficulty level.

The term “candidate educational resources” refers to a plurality of educational content items retrieved from the educational resource database as potential options for recommendation to the user.

The term “resource list data” refers to structured information describing candidate educational resources, including at least resource identifiers, titles, topics, difficulty levels, and other metadata, which is supplied to the generative AI model.

The term “recommendation” refers to a result produced by the generative AI model or the processor indicating one or more educational resources selected from the candidate educational resources for presentation or use in a learning path.

The term “learning path” refers to an ordered or partially ordered set of learning steps defined for the user, each learning step being associated with at least one educational resource and arranged so as to guide the user toward the learning objective.

The term “learning step” refers to a unit of learning activity within the learning path, such as viewing content, completing an exercise, or taking an assessment, that is individually identifiable and associated with at least one educational resource.

The term “structured data” refers to data formatted according to a predefined schema, such as key-value pairs, records, or tables, enabling consistent storage, retrieval, and processing by the system.

The term “learning progress information” refers to data indicating a state of completion or performance of the user with respect to educational resources or learning steps, including at least completion flags, timestamps, or assessment scores.

The term “presentation data” refers to data generated by the processor and transmitted to the user terminal for display or other output, including at least information about the learning path, recommended educational resources, and explanation messages.

The term “modify or redesign the learning path” refers to a processing operation that changes the structure or parameters of a stored learning path, including at least adding, removing, reordering, splitting, or merging learning steps and adjusting difficulty levels in response to updated information.

The term “additional natural language input” refers to one or more further natural language messages provided by the user after an initial input, including feedback, questions, or comments, which are used by the system to refine the learning objective, emotional state, or learning path.

The term “dynamically update” refers to adjusting stored data or system behavior during operation in response to new inputs or conditions, without requiring manual reconfiguration or system restart.

In one embodiment, a server cooperates with at least one terminal to implement the claimed system. The server includes a hardware processor, a main memory, a nonvolatile storage device, a network interface, and one or more data stores. The terminal includes a display, an input interface such as a touchscreen or keyboard, a local processor, and a communication module. The server and the terminal communicate through a digital communication network using, for example, a packet-based protocol.

The server executes an application implemented, for example, in a high-level programming language running on an operating system. The server stores program modules including a natural language processing module, an emotion estimation module, a prompt generation module, a generative AI client module, a recommendation module, and a learning-path management module. The server further stores a plurality of data structures including at least a user profile store, a learning objective store, an educational resource database, a progress store, and a learning path store.

The terminal executes an application that provides a user interface. The terminal displays input fields in which the user can enter natural language sentences describing learning intentions, concerns, or feedback. The terminal converts typed or spoken natural language into character strings encoded using a standard character encoding. The terminal encapsulates these character strings and associated metadata, such as a user identifier and timestamps, into structured records, and transmits them to the server through the communication module.

The server receives the natural language input data in the form of these structured records.

The server stores the raw input text and associated metadata in the user profile store and in a separate input log. The server uses a natural language processing module that may be implemented using a library such as a statistical or neural language-processing toolkit. The server tokenizes the text, performs part-of-speech tagging, extracts named entities, and normalizes words using internal dictionaries and tokenization rules. The server generates feature vectors representing the text, for example as dense embeddings obtained from a pre-trained embedding model or as sparse vectors obtained from term-frequency calculations.

The server estimates an emotional state of the user based on the natural language input. The server may compute sentiment scores using a rule-based lexicon model, such as a polarity lexicon, and may also feed the feature vectors into an emotion classifier implemented as a neural network. In one implementation, the emotion classifier uses a recurrent or transformer-based architecture with an input layer receiving token embeddings, one or more attention layers aggregating contextual information, and an output layer producing continuous values corresponding to emotional dimensions such as anxiety, fear, boredom, and confidence. The server uses an error function such as cross-entropy or mean squared error during training of this classifier, and updates the model weights using gradient-based optimization. By combining lexicon-based signals and neural network outputs, the server generates normalized emotional state scores with higher robustness than either approach alone.

The server constructs a learning objective from the natural language input and the emotional state. The server uses a generative AI client module to interact with a generative AI model.

The generative AI model may be implemented as a large neural language model trained on a corpus of text, using, for example, a transformer architecture with multiple self-attention layers, layer normalization, and feed-forward sublayers. The server does not merely send raw text to the model; instead, the server generates a plurality of prompt sentences according to templates and internal state.

In one example, the server generates a first prompt sentence for learning-objective extraction in the following form:

“User text: ‘I want to learn data science but I am bad at math and feel nervous.’

Task: Identify the user's learning objective. Output the learning field, the proficiency level (beginner, intermediate, or advanced), and any learning constraints.”

In another example, the server generates a similar first prompt sentence:

“The user wrote: ‘I want to learn Python programming but it looks scary and difficult.’ Analyze this message and identify a concise learning objective, including subject, level, and constraints.”

The server transmits such prompt sentences to the generative AI model. The server supplies the prompt sentence as a sequence of tokens and may specify model parameters, such as maximum output length, temperature for sampling, and decoding strategy. The generative AI model processes the prompt by propagating token embeddings through stacked attention layers and non-linear transformations, and generates a response that includes structured expressions of a learning objective.

The server parses the output from the generative AI model, using deterministic parsers or pattern-matching rules, to extract a learning field, a proficiency level, and one or more constraints, for example a weak background in a particular prerequisite subject or a desire for low-stress learning. The server stores the parsed information in the learning objective store as objective information associated with the user.

The server refines this objective information using the emotional state. For example, if the emotional state indicates high anxiety or fear, the server modifies the difficulty level to a lower level than that directly suggested by the generative AI model. The server also adds constraint conditions such as “short sessions,” “frequent reassurance,” or “focus on fundamentals” to the objective information. The server uses explicit rules to relate emotional state thresholds to difficulty adjustments and constraint additions, rather than relying solely on the generative AI model. These rules may specify, for example, that when an anxiety score exceeds a threshold and a math-related entity is present, the server must constrain resource selection to materials containing introductory-level mathematics, and must split learning steps into shorter segments.

The server accesses the educational resource database to retrieve candidate educational resources satisfying the refined objective information. The educational resource database stores records with fields including at least a resource identifier, title, topic, associated learning field, difficulty level, estimated duration, prerequisite tags, and evaluation metrics such as ratings and completion statistics. The server uses structured queries to filter resources by topic and difficulty level, and to apply constraints such as time limits or required prerequisites. In addition to these filters, the server may compute similarity scores between resource descriptions and the objective information using vector representations, thereby ranking resources before model-based refinement.

The server generates a second type of prompt sentence, for example:

“User goal: beginner-level data science with weak math background and high anxiety.

Here is a list of candidate courses with brief descriptions and durations.

Select up to three courses that best fit this user and explain why each course is appropriate.”

In another example, the server generates a second prompt sentence in the following form: “User objective: beginner Python programming, user feels scared about difficulty.

Candidate resources: [course A description], [course B description], [course C description]. Choose the most suitable courses for a low-stress learning experience and provide short reasons.”

The server transmits such second prompt sentences, along with the resource list data extracted from the educational resource database, to the generative AI model. The model processes the context and generates a response that identifies one or more recommended resources along with justifications. The server parses the response and maps the recommended resource identifiers or names back to the internal educational resource identifiers stored in the database.

The server then constructs a learning path as a structured data object. The learning path includes an ordered or partially ordered list of learning steps. Each learning step references a resource identifier and includes attributes such as an expected duration, difficulty level, prerequisite step references, and contextual messages. The server may use algorithmic rules to split long courses into multiple steps, to insert review steps, or to interleave conceptual explanations with exercises. The server stores the learning path in the learning path store linked to the user identifier and the learning objective.

The server may generate an additional prompt sentence to obtain a human-readable explanation of the learning path, for example:

“User goal: beginner data science with weak math skills and high anxiety.

Proposed learning path: [list of steps].

Explain this path to the user in simple and encouraging language in less than 200 words.”

The server sends this prompt sentence to the generative AI model, receives explanatory text, and stores this text as part of the presentation data.

The terminal receives presentation data from the server, including at least the summarized objective information, the recommended educational resources, the structured learning path, and the explanatory text. The terminal displays a graphical interface that shows the user a list of recommended courses, a representation of the learning path as a timeline or checklist, and the supportive explanation. The terminal may also display emotional indicators or confidence levels to allow the user to understand why specific content has been selected.

The user selects learning steps via the terminal. The terminal responds by launching the associated educational resource, for example by opening a web-based lesson or by starting a media player. The terminal records learning events, including starting and finishing a step, answer correctness in quizzes, time spent, and explicit feedback messages input by the user.

The terminal transmits aggregated progress records to the server at intervals or upon request.

The server updates the progress store with these events. The server computes progress metrics, such as completion percentages, average scores, and time per step. The server also feeds new natural language feedback into the emotion estimation module to update the emotional state. The server then uses the learning-path management module to determine whether the current path remains appropriate. For example, the server may detect that the user is completing steps significantly faster and with higher scores than expected, while the emotional state indicates low anxiety and high boredom. In such a case, the server decides to increase the challenge by skipping certain review steps or by inserting more advanced materials.

The server uses a further type of prompt sentence to instruct the generative AI model to redesign or modify the existing learning path. In one example, the server generates the following prompt:

“User goal: beginner data science with weak math background.

Current learning path and progress: [structured description].

Current emotional state: boredom is high, anxiety is low.

Update the learning path to increase challenge and reduce repetition, while preserving continuity toward the learning goal.”

In another example, the server generates a similar prompt sentence to address heightened anxiety:

“User objective: Python programming fundamentals.

Current learning path and progress: [structured description].

Current emotional state: anxiety is high and quiz scores are low.

Modify the learning path to insert easier review materials and shorter steps, and explain the changes.”

The server sends this prompt to the generative AI model, which outputs a proposed new ordering and composition of learning steps. The server checks that the proposed steps correspond to known resources and that dependencies are consistent. The server then updates the learning path store with the modified structure and notifies the terminal.

By repeatedly using structured prompt sentences and controlled parsing to mediate between the internal data structures and the generative AI model, the server improves the internal organization of computations. The server does not rely on ad-hoc, one-off text queries but defines a set of prompt categories with associated input schemas and output schemas. This design reduces the need for complex post-processing logic, decreases the number of round trips to the generative AI model, and reduces computational overhead for both model inference and database access. The server also reduces communication load by transmitting to the model only compact, structured summaries of resources and states instead of full content whenever possible.

The system yields technical improvements over conventional designs that rely solely on static rule engines or single-stage model calls. Because the server accounts for emotional state when redefining difficulty levels and constraints, the system can avoid unnecessary recommendations of inappropriately difficult content. This reduces wasted processing on analyzing or rendering unsuitable resources and lowers the number of times the system must reconstruct the learning path due to user disengagement. By training an emotion classifier and by combining it with rule-based adjustments, the server detects misalignment early and adapts the path more quickly, leading to fewer computation cycles for error correction.

The server advantageously implements modular data flows between the natural language processing module, the emotion estimation module, the generative AI client module, and the learning-path management module. Each module exchanges structured data, such as feature vectors, emotional scores, and learning step descriptors. This modularity allows parallelization and caching; for instance, the server can reuse prior emotion estimates or objective information for subsequent updates without repeating full analysis, thereby improving throughput and latency across many users.

The system is not limited to a single generative AI architecture. In another embodiment, the server uses a smaller generative model for some prompts and a larger model for complex path redesign, selecting the model according to available processing capacity and required output precision. The server can alter parameters such as context window size, number of decoding beams, and temperature as part of internal optimization rules, which further tunes resource usage. For example, the server may lower the decoding temperature and shorten output length when requesting strictly structured path updates, thereby reducing inference time and parsing complexity.

In a further embodiment, the server integrates alternative emotion estimation methods, such as multimodal models that also ingest speech prosody or facial-expression features captured by the terminal, provided that privacy and legal requirements are met. The server standardizes these heterogeneous emotion inputs into the same internal representation, ensuring that the learning-path management module can rely on a unified emotion schema. This design reduces implementation complexity and facilitates replacement or improvement of underlying emotion models without affecting upstream or downstream modules.

In yet another embodiment, the server supports multiple learning fields and objective hierarchies. The learning objective store may represent objectives as nodes in a graph, with edges representing prerequisite relations between knowledge units. The generative AI model, instructed via appropriate prompt sentences, proposes how to traverse this graph for a particular user, while the server ensures structural consistency and applies additional rule checks. This graph-based representation allows the server to compute alternative paths and to select among them based on quantitative measures such as estimated time to completion or cognitive load, which enhances the technical quality of path planning.

The system therefore represents more than a mere automation of human teaching decisions. The server introduces specific data structures for objectives, resources, progress, emotions, and paths; defines a family of prompt sentences that bind these structures to the generative AI model; and executes algorithmic rules that integrate model outputs with emotion-aware adjustments. These technical configurations provide concrete improvements in computational efficiency, precision of recommendations, adaptability of stored paths, and stability of the overall system relative to conventional architectures that lack such coordinated use of generative AI models and structured prompt sentences.

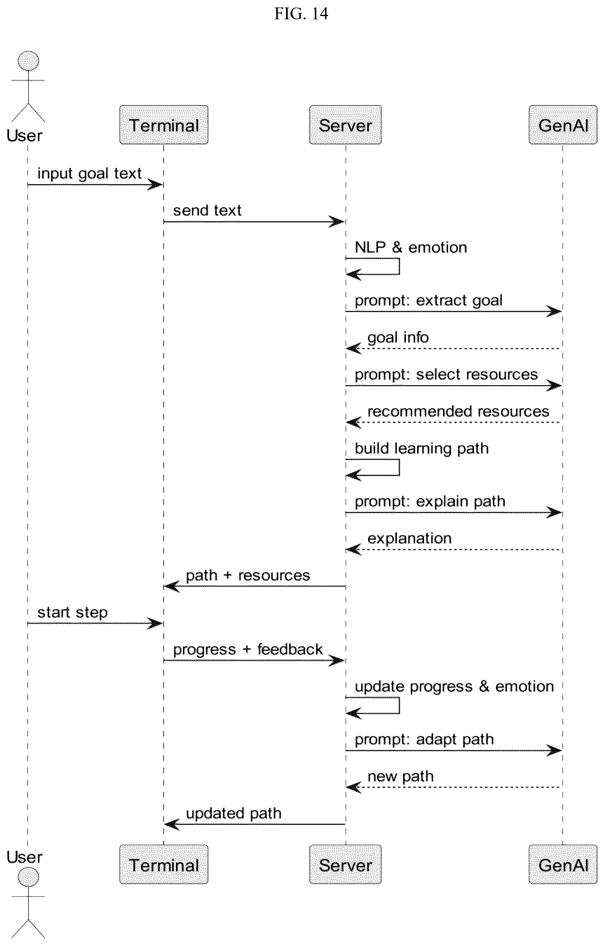

The following describes the processing flow using FIG. 14.

### Step 1:

The user inputs an initial learning request on the terminal.

The user types or speaks a natural language message such as “I want to learn data science but I am bad at math and feel nervous” into an input field displayed on the terminal.

The terminal receives this message as a character string and combines it with a user identifier and timestamp to form an input record.

Input: raw user text, user ID, timestamp.

Output: a structured input record containing the natural language text and metadata.

### Step 2:

The terminal transmits the input record to the server.

The terminal encodes the input record in a structured format and sends it via a network interface to an API endpoint on the server using a network protocol.

Input: structured input record at the terminal.

Output: network request containing the input record delivered to the server.

### Step 3:

The server receives and logs the user input record.

The server reads the network request, validates mandatory fields, and writes the input record into an input log data store and a user-input table.

Input: network request with the structured input record.

Output: stored input row in a persistent data store and an in-memory representation of the input record.

### Step 4:

The server performs basic natural language preprocessing.

The server passes the raw text through a natural language processing module that tokenizes the text, normalizes case, removes or marks stop-words, and may compute token embeddings. The server generates a list of tokens, part-of-speech tags, and optionally a feature vector for downstream use.

Input: raw text string from the input record.

Output: token list, linguistic annotations, and feature representations.

### Step 5:

The server estimates the user's emotional state from the natural language text.

The server feeds the token list and feature vector into an emotion estimation module that may combine lexicon-based sentiment rules and a trained neural classifier. The classifier computes scores for emotions such as anxiety, fear, boredom, and confidence. The server normalizes these scores and stores them as an emotional state record linked to the input.

Input: tokens, linguistic features, and raw text.

Output: emotional state scores and an associated emotional state record.

### Step 6:

The server generates a first prompt sentence for a generative AI model to extract a learning objective.

The server inserts the raw user text into a template and adds explicit instructions about the required output, such as:

“User text: ‘I want to learn data science but I am bad at math and feel nervous.’

Task: Identify the user's learning objective. Output the learning field, the proficiency level (beginner, intermediate, or advanced), and any learning constraints.”

The server constructs this prompt sentence as a contiguous text string and associates it with request parameters for the generative AI model.

Input: raw user text and system prompt template.

Output: first prompt sentence ready for submission to the generative AI model.

### Step 7:

The server calls the generative AI model to obtain a learning objective.

The server sends the first prompt sentence to the generative AI model through a client interface, specifying decoding parameters such as maximum length and temperature. The generative AI model processes the prompt and returns a textual response describing the learning field, proficiency level, and constraints. The server parses the response using pattern rules to extract these elements as structured fields.

Input: first prompt sentence.

Output: structured learning objective data including learning field, proficiency level, and constraints.

### Step 8:

The server refines the learning objective using the emotional state.

The server combines the structured learning objective with the emotional state scores. The server applies rule-based logic to adjust the proficiency level and add or modify constraints. For example, if anxiety is high and a prerequisite topic is mentioned, the server lowers the difficulty level and adds constraints such as “include very basic review” and “short lessons.”

Input: structured learning objective and emotional state scores.

Output: refined objective information including adjusted difficulty level and updated constraint conditions.

### Step 9:

The server retrieves candidate educational resources from the educational resource database.

The server constructs a database query using the refined learning objective, filtering by learning field, difficulty level, and tags that match constraints such as math basics or low cognitive load. The server executes the query and retrieves resource records that satisfy these conditions.

Input: refined objective information and resource database.

Output: a list of candidate educational resource records with identifiers and metadata.

### Step 10:

The server assembles resource list data for model-assisted selection.

The server selects key fields from each candidate resource, such as title, brief description, topic, difficulty level, and duration, and formats them as a concise resource list description. The server prepares this description as a text block suitable for inclusion in a prompt sentence.

Input: candidate educational resource records.

Output: textual resource list data summarizing candidate resources.

### Step 11:

The server generates a second prompt sentence for the generative AI model to select or rank resources.

The server combines the refined objective information and the resource list data into a second prompt sentence, for example:

“User goal: beginner-level data science with weak math background and high anxiety.

Here is a list of candidate courses with brief descriptions and durations: [course descriptions].

Select up to three courses that best fit this user and explain why each course is appropriate.”

The server prepares this text for submission to the generative AI model.

Input: refined objective information and resource list data.

Output: second prompt sentence for resource selection or ranking.

### Step 12:

The server calls the generative AI model to recommend educational resources.

The server sends the second prompt sentence to the generative AI model. The generative AI model processes the context and returns a response that indicates which resources are most suitable and provides reasons. The server parses the response to obtain selected resource identifiers or names and corresponding explanations.

Input: second prompt sentence.

Output: selected educational resource identifiers and explanatory text.

### Step 13:

The server builds a structured learning path from the selected resources.

The server creates a sequence of learning steps, each linking to a selected resource and optionally to specific sections within that resource. The server sets attributes for each step, such as order index, difficulty marker, estimated time, and prerequisite references. The server may split longer resources into multiple steps to satisfy the constraints of short sessions or reduced cognitive load.

Input: selected educational resource identifiers, resource metadata, and refined objective information.

Output: structured learning path object composed of ordered learning steps.

### Step 14:

The server generates an explanatory prompt sentence for a user-friendly description of the learning path.

The server constructs a third prompt sentence that describes the user's goal and summarizes the learning path, for example:

“User goal: beginner data science with weak math skills and high anxiety.

Proposed learning path: [list of steps].

Explain this path to the user in simple and encouraging language in less than 200 words.”

The server prepares this text for submission to the generative AI model.

Input: structured learning path and refined objective information.

Output: third prompt sentence requesting a path explanation.

### Step 15:

The server calls the generative AI model to generate the learning path explanation.

The server sends the third prompt sentence to the generative AI model, which returns a short narrative explanation. The server stores this explanation together with the learning path for later presentation.

Input: third prompt sentence.

Output: explanatory text describing the learning path.

### Step 16:

The server generates presentation data for the terminal.

The server aggregates the refined objective information, the selected resources, the learning path structure, and the explanatory text into a unified response object. The server serializes this object and sends it to the terminal via the network interface.

Input: refined objective information, learning path, and path explanation.

Output: presentation data transmitted to the terminal.

### Step 17:

The terminal displays the learning objective, recommended resources, and learning path.

The terminal parses the presentation data and updates the user interface. The terminal shows the summarized learning objective, lists the recommended courses or resources with “Start” controls, and renders the learning path as a sequence of steps with checkboxes or progress indicators. The terminal also displays the explanatory text provided by the server.

Input: presentation data from the server.

Output: updated graphical user interface on the terminal.

### Step 18:

The user selects and executes a learning step on the terminal.

The user chooses one of the recommended resources or steps by tapping or clicking on the interface. The terminal uses the associated resource URL or identifier to launch the content, for example in a web view or media player. The terminal records an event indicating that this step has started.

Input: user selection of a learning step, resource identifier.

Output: started learning session and a “step started” event record.

### Step 19:

The terminal monitors the user's interaction and records progress events.

The terminal detects completion of videos, submission of quizzes, and navigation between lesson sections. The terminal calculates time spent on each step and records scores or completion flags. The terminal bundles these events into progress data for transmission.

Input: user interaction events during content consumption.

Output: aggregated progress records containing step identifiers, completion status, scores, and durations.

### Step 20:

The terminal transmits progress data and optional feedback text to the server.

The user may also enter additional feedback, such as “This part is too hard” or “I am bored with repetition,” via the terminal interface. The terminal combines this feedback text with the progress records and sends them to the server as structured progress and feedback messages.

Input: progress records and feedback text at the terminal.

Output: network request containing progress and feedback data delivered to the server.

### Step 21:

The server updates stored progress and re-estimates the emotional state.

The server writes progress events into the progress store and updates completion percentages and current step indices. The server feeds new feedback text into the emotion estimation module to compute updated emotional scores. The server associates these updated scores with the corresponding learning path state.

Input: progress records and feedback text.

Output: updated progress data and updated emotional state records.

### Step 22:

The server determines whether the learning path should be adapted.

The server evaluates logical conditions that compare progress metrics and emotional scores against thresholds. For example, the server checks whether boredom is high and quiz scores are high, or whether anxiety is high and scores are low. If these conditions are satisfied, the server decides that the current learning path must be modified.

Input: updated progress metrics and emotional state scores.

Output: adaptation decision flag and parameters indicating the type of modification needed.

### Step 23:

The server generates an adaptation prompt sentence for the generative AI model.

When adaptation is needed, the server summarizes the current learning path and the user's progress in a compact textual description and combines this with the updated emotional state.

The server then constructs a fourth prompt sentence such as:

“User objective: beginner data science with weak math background.

Current learning path and progress: [summary].

Current emotional state: boredom is high, anxiety is low.

Update the learning path to increase challenge and reduce repetition while keeping the user on track toward the objective.”

Input: current learning path, progress summary, emotional state, and adaptation decision.

Output: fourth prompt sentence for path modification.

### Step 24:

The server calls the generative AI model to propose a modified learning path.

The server sends the fourth prompt sentence to the generative AI model. The generative AI model generates a proposed new ordering and selection of learning steps. The server parses the model's response, identifies referenced resources or step types, and maps them to existing resources in the educational resource database.

Input: fourth prompt sentence.

Output: proposed modified learning path description.

### Step 25:

The server validates and applies the modified learning path.

The server checks the proposed modifications for consistency, verifying that all referenced resources exist and that prerequisites are not violated. The server updates the stored learning path structure to reflect new step orders, insertions, deletions, or difficulty changes.

Input: proposed modified learning path and current stored path.

Output: updated learning path stored in the learning path store.

### Step 26:

The server generates updated presentation data and sends it to the terminal.

The server serializes the updated learning path, along with any new explanatory text or messages, into a response. The server transmits this response to the terminal so that the user interface can reflect the adaptation.

Input: updated learning path and optional new explanation.

Output: updated presentation data delivered to the terminal.

### Step 27:

The terminal refreshes the user interface according to the updated learning path.

The terminal reads the updated presentation data and re-renders the learning steps. The terminal marks completed steps, highlights the newly recommended “next step,” and adds or removes steps as indicated. The terminal may display a short message explaining that the path has been adjusted to better match the user's performance and feelings.

Input: updated presentation data from the server.

Output: refreshed user interface guiding the user along the modified learning path.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

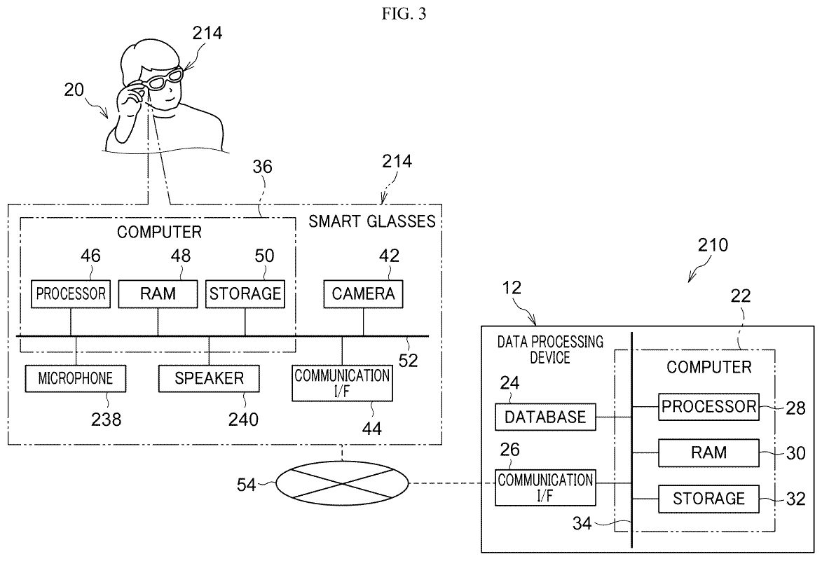

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

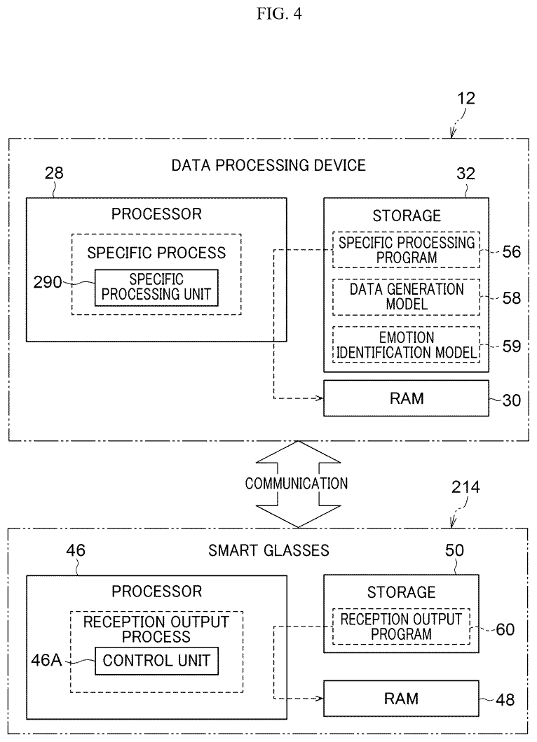

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

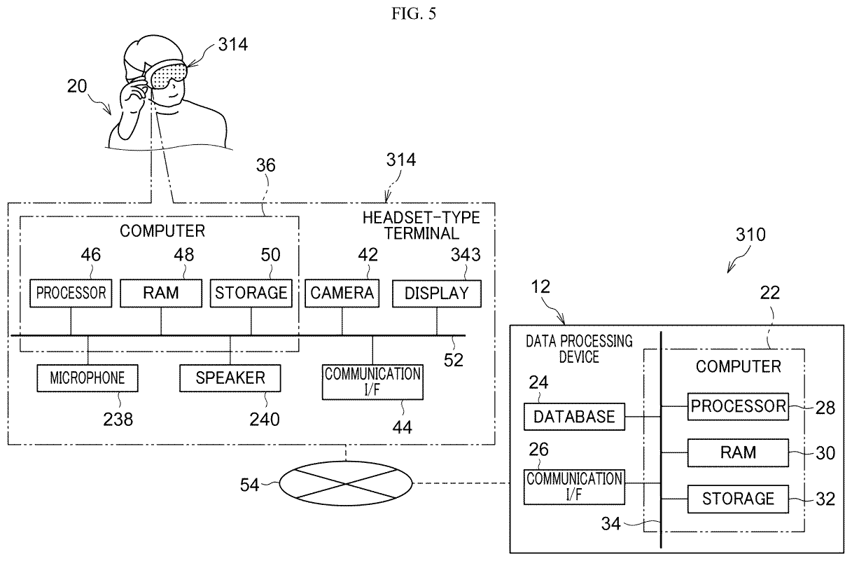

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

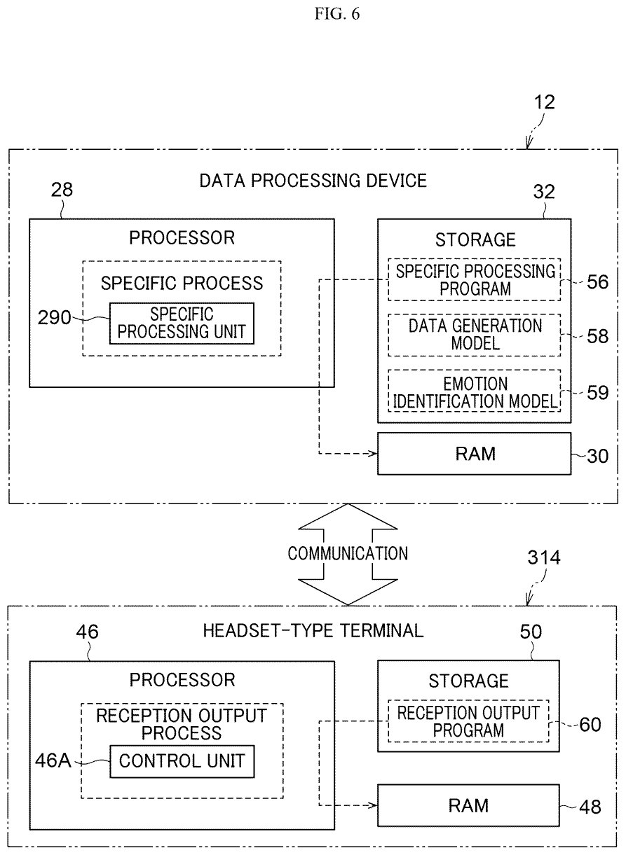

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

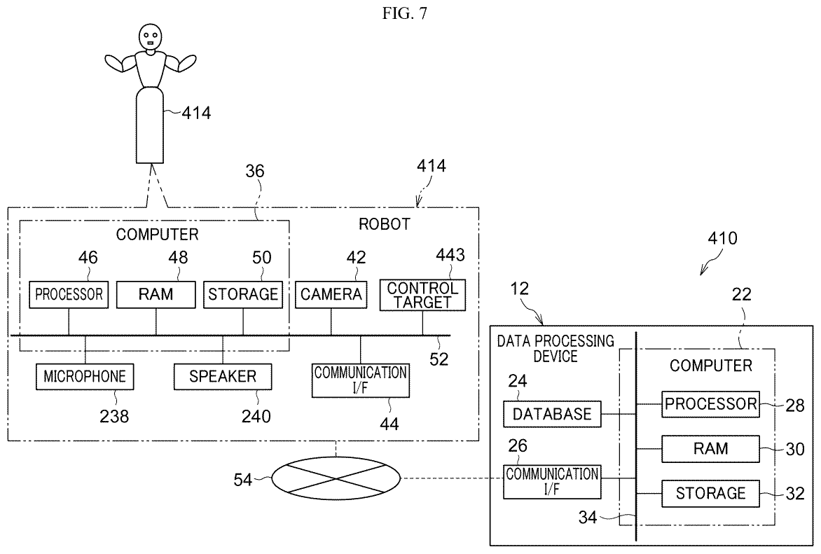

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

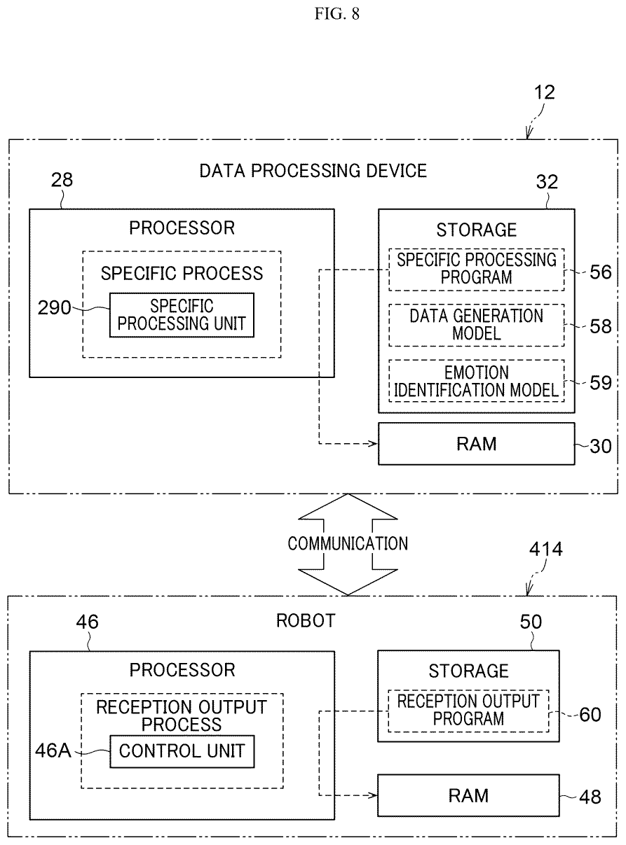

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

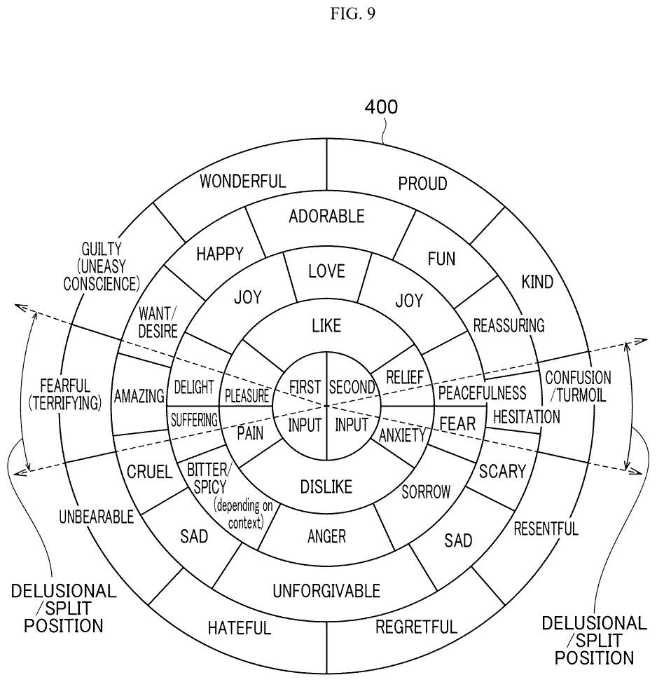

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

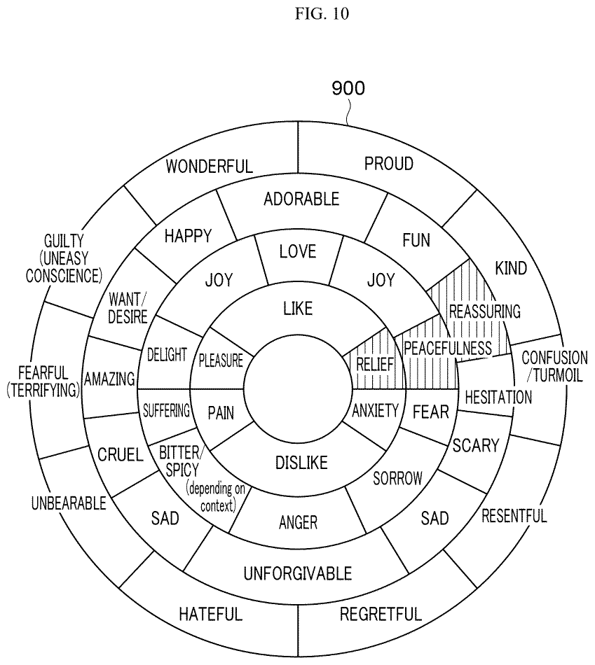

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from an information processing terminal operated by a user, input data in natural language regarding a learning objective of the user, convert the input data into structured text data, and receive the structured text data via a communication network,
generate, from the structured text data, a prompt sentence to be input to a generative AI model, transmit the prompt sentence to the generative AI model, cause the generative AI model to extract information indicating at least a learning objective and learning skills required for the learning objective from the input data, and obtain an extraction result as structured learning objective data,
select, on the basis of the structured learning objective data, at least one standardized learning category and at least one standardized skill category from among standardized categories stored in a classification database, normalize the learning objective and the learning skills into the standardized categories, and store the normalized data as user profile data in a storage device,
search, on the basis of the user profile data, a learning material database for a plurality of educational content candidates, generate, from metadata of the educational content candidates, a prompt sentence to be input to the generative AI model, transmit the prompt sentence to the generative AI model, cause the generative AI model to perform selection and ordering of the educational content candidates, and generate learning path data for the user on the basis of a result of the selection and the ordering,
transmit the learning path data to the information processing terminal, and cause the information processing terminal to generate display control data including identification information and presentation order of educational content included in the learning path data and to present the learning path on a user interface in accordance with the display control data,
receive, from the information processing terminal, progress event data generated in accordance with operations by the user regarding viewing, starting learning, completing learning, or evaluating each educational content, and store the progress event data as progress history data in the storage device, and
generate, from at least the progress history data and the user profile data, a prompt sentence to be input to the generative AI model, transmit the prompt sentence to the generative AI model, obtain proposal data regarding modification or addition of the learning path from the generative AI model, and dynamically update the learning path data on the basis of the proposal data.

### (Supplementary 2)

The system according to supplementary 1,
wherein the processor is configured to
analyze, from the progress history data, at least completion rate data, learning time data, and evaluation data, generate, from an analysis result, a prompt sentence to be input to the generative AI model, cause the generative AI model, on the basis of the prompt sentence, to recommend at least one of remedial educational content and difficulty-adjusted educational content, and insert, on the basis of a recommendation result, at least one of a remedial section and a difficulty-changed section into the learning path data.

### (Supplementary 3)

The system according to supplementary 1,
wherein the processor is configured to
generate, from newly received natural language text regarding a learning objective of the user, the existing user profile data, and the progress history data, a prompt sentence to be input to the generative AI model, cause the generative AI model, on the basis of the prompt sentence, to estimate at least a relationship and a priority among a plurality of learning objectives, and reconstruct at least the standardized learning categories and the learning path data on the basis of an estimation result.

### Application Example 1

### (Supplementary 1)

A system comprising a processor,
wherein the processor is configured to
receive goal information expressed in natural language from a user-side information processing apparatus, normalize the goal information, and store the normalized goal information as an analysis target string,
generate a prompt sentence including instruction information for converting the analysis target string into a representation vector or a classification result by use of a natural language processing learning model, input the prompt sentence into a generative information processing model, and obtain analysis result information from the generative information processing model,
set search conditions for an information storage apparatus that stores education resource information on the basis of the analysis result information, acquire candidate education resource information from the information storage apparatus, and rank the candidate education resource information according to the analysis result information to construct learning path information,
generate a prompt sentence including the analysis result information and the candidate education resource information in order to cause the generative information processing model to generate the learning path information and reasons for presenting respective education resources, input the prompt sentence into the generative information processing model, and obtain explanation text information from the generative information processing model, transmit the learning path information and the explanation text information to the user-side information processing apparatus so that the learning path information and the explanation text information are presented on the user-side information processing apparatus,
record learning execution status information received from the user-side information processing apparatus in a progress information storage apparatus, and perform condition determination for updating the learning path information on the basis of progress information recorded in the progress information storage apparatus, and
determine a next education resource to be presented on the basis of the progress information and updated learning path information, generate a prompt sentence for causing the generative information processing model to generate update explanation information including a content of the determination and a reason for the update, input the prompt sentence into the generative information processing model, and obtain the update explanation information from the generative information processing model.

### (Supplementary 2)

The system according to supplementary 1,
wherein the processor is configured to
determine, on the basis of the learning execution status information recorded in the progress information storage apparatus, completed education resources and uncompleted education resources among current learning path information, determine update conditions and update contents for changing an order of the uncompleted education resources or inserting a new education resource, generate a prompt sentence that includes the update conditions and the update contents as input to the generative information processing model, and dynamically reconstruct the learning path information according to a response obtained from the generative information processing model.

### (Supplementary 3)

The system according to supplementary 1,
wherein the processor is configured to
cause the natural language processing learning model to perform feature amount calculation to extract a learning domain attribute, a proficiency attribute, and a related skill attribute from the analysis target string, and include a result of the feature amount calculation in a prompt sentence to be input to the generative information processing model so that the generative information processing model executes summarization and classification of goal information for learning.

### Example 2

### (Supplementary 1)

A system comprising a processor,
wherein the processor is configured to
store character information acquired from a user terminal in a storage medium and construct inquiry information including the character information as a prompt sentence to be input to a plurality of generative AI models,
cause a generative AI model having a natural language processing function to execute analysis processing using the prompt sentence, and acquire structured information indicating a learning purpose, a capability level, and a target field included in the character information from a user,
map the structured information to a classification scheme of higher-level concepts to specify a learning-goal category, and retrieve, from the storage medium, a set of educational content associated with the learning-goal category,
perform ordering of the set of educational content based on difficulty information and prerequisite relationship information, and input, to the generative AI model, a prompt sentence including the set of educational content and the learning-goal category to cause the generative AI model to generate an explanatory text and a recommended learning path, store the recommended learning path in association with user identification information in the storage medium, and transmit the recommended learning path and the explanatory text to the user terminal, and
aggregate learning execution result information acquired from the user terminal to calculate learning progress information, generate a prompt sentence including the learning progress information and the learning execution result information, input the prompt sentence to the generative AI model so that the generative AI model specifies next educational content to be learned, and dynamically update the recommended learning path.

### (Supplementary 2)

The system according to supplementary 1,
wherein the processor is configured to
generate, based on the learning progress information and the learning execution result information, a prompt sentence to be input to the generative AI model for adding review content or supplementary content corresponding to educational content whose achievement level does not satisfy a predetermined condition, or for replacing educational content determined to have excessive difficulty with substitute content, and reconstruct the recommended learning path based on an output result obtained from the generative AI model.

### (Supplementary 3)

The system according to supplementary 1,
wherein the processor is configured to
use history information including the character information from the user and the learning progress information to input, to the generative AI model, a prompt sentence for redefining a learning goal and reclassifying the learning-goal category, and regenerate the set of educational content and the recommended learning path in accordance with an updated learning-goal category obtained by the generative AI model.

### Application Example 2

### (Supplementary 1)

A system comprising a processor,
wherein the processor is configured to
receive natural language input data from a user terminal and generate a prompt sentence for instructing a generative AI model to identify a learning objective based on the input data, generate a prompt sentence for instructing the generative AI model to perform natural language analysis of the input data,
estimate an emotional state of the user on the basis of an analysis result returned from the generative AI model,
redefine the learning objective as objective information including a difficulty level and constraint conditions corresponding to the emotional state and the analysis result,
generate a prompt sentence for inputting to the generative AI model resource list data including information on candidate educational resources extracted from an educational resource database on the basis of the redefined objective information,
select, on the basis of a response from the generative AI model, at least one educational resource to be recommended to the user from among the candidate educational resources and generate a learning path including a plurality of learning steps using the at least one educational resource,
generate presentation data for presenting the learning path and explanation information concerning the educational resources to the user, and
generate a prompt sentence for instructing the generative AI model to modify or redesign the learning path on the basis of learning progress information and additional natural language input transmitted from the user terminal, and dynamically update the learning path according to a response from the generative AI model.

### (Supplementary 2)

The system according to supplementary 1,
wherein the processor is configured to
generate a prompt sentence for the generative AI model to perform an update process that changes at least one of an order, a difficulty level, a division number, an addition, and a deletion of the learning steps included in the learning path according to the learning progress information and the emotional state, and dynamically adjust the learning path on the basis of a response from the generative AI model.

### (Supplementary 3)

The system according to supplementary 1,
wherein the processor is configured to
generate a prompt sentence in a format that causes the generative AI model to extract objective information including a learning field, a proficiency level, and learning constraint conditions from the natural language input data of the user, and record the objective information as structured data on the basis of a response from the generative AI model.

What is claimed is:

1. A system comprising:
circuitry configured to:
receive, via a communication interface coupled to a packet-switched network, natural language input data from a terminal device operated by a user;
convert the natural language input data into structured text data, generate structured prompt sentences from the structured text data, and obtain structured objective data comprising at least a user objective and associated skill categories from responses of a generative neural network model;
normalize the structured objective data by selecting at least one standardized category and at least one standardized skill category from a classification data set stored in a storage device, and store resulting user profile data in the storage device;
search a content data set for content candidates based on the user profile data, generate further prompt sentences from metadata of the content candidates, obtain selection and ordering information from the generative neural network model, and generate path data for the user based on the selection and ordering information;
transmit the path data to the terminal device via the communication interface; and
receive progress event data from the terminal device, generate update prompt sentences from the progress event data and the user profile data, and dynamically update the path data based on proposal data obtained from responses of the generative neural network model.

2. The system according to claim 1, wherein the circuitry is configured to convert the natural language input data into the structured text data by applying at least tokenization and sentence boundary detection, and to generate the structured prompt sentences by encoding the structured text data with task-specific instruction prefixes as input sequences for the generative neural network model.

3. The system according to claim 2, wherein the circuitry is configured to extract the structured objective data by parsing the response of the generative neural network model to identify at least an objective field, a proficiency level field, and a constraint conditions field, and to validate the extracted fields against a schema definition before storing in the storage device.

4. The system according to claim 3, wherein the structured objective data includes a learning field identifier and a proficiency level, and the circuitry is configured to normalize the learning field identifier by mapping it to a standardized learning category stored in the classification data set, and to generate the user profile data comprising the standardized learning category, the standardized skill category, and the proficiency level.

5. The system according to claim 4, wherein the circuitry is configured to search the content data set by executing a query comprising the standardized learning category and the standardized skill category as filter conditions, and to retrieve a plurality of content candidates each associated with metadata comprising at least a content identifier, a difficulty level, and a format type.

6. The system according to claim 1, wherein the circuitry is configured to generate the further prompt sentences by encoding the metadata of the content candidates together with the user profile data as a structured input sequence, and to parse the selection and ordering information from the generative neural network model response as a ranked list of content identifiers with associated justification data.

7. The system according to claim 6, wherein the circuitry is configured to generate the path data by assembling the ranked list of content identifiers into a sequential structure, and to associate each content item with at least an estimated completion duration and a dependency relationship with preceding content items.

8. The system according to claim 7, wherein the circuitry is configured to transmit the path data to the terminal device in a structured format and to generate control information for causing the terminal device to render the path data as a visual sequence of content items with associated progress indicators.

9. The system according to claim 1, wherein the circuitry is configured to receive the progress event data comprising at least one of a viewing event, a start event, a completion event, or an evaluation event for each content item, and to store each progress event with a timestamp and a content identifier as progress history data in the storage device.

10. The system according to claim 9, wherein the circuitry is configured to generate the update prompt sentences by combining the progress history data, the user profile data, and a representation of the current path data into a structured input sequence, and to obtain proposal data from the generative neural network model specifying at least one of addition, removal, or reordering of content items in the path data.

11. The system according to claim 10, wherein the circuitry is configured to dynamically update the path data by applying the modifications specified in the proposal data to the current path data, and to retransmit the updated path data to the terminal device via the communication interface.

12. The system according to claim 1, wherein the circuitry is configured to receive evaluation data from the terminal device comprising a user-assigned rating for a content item, and to incorporate the evaluation data as a feedback signal into the update prompt sentences to bias subsequent selection and ordering information toward higher-rated content formats and difficulty levels.

13. The system according to claim 1, wherein the circuitry is configured to estimate an emotional state of the user based on text data or voice data received from the terminal device, and to incorporate the estimated emotional state into the structured prompt sentences to adjust a response tone and a content selection preference of the generative neural network model.

14. The system according to claim 13, wherein the circuitry is configured to classify the emotional state into an emotional category and to select a prompt sentence template from a plurality of prompt sentence templates based on the classified emotional category, the prompt sentence template specifying at least a guidance level and a detail level for the generative neural network model response.

15. The system according to claim 1, wherein the circuitry is configured to generate a prompt sentence in a format that causes the generative neural network model to extract objective information including a target field, a proficiency level, and constraint conditions from the natural language input data, and to record the extracted objective information as structured data in the storage device based on a response from the generative neural network model.

16. The system according to claim 1, wherein the circuitry is configured to monitor a completion rate of content items in the path data derived from the progress event data, and to trigger generation of the update prompt sentences when the completion rate satisfies a threshold, the update prompt sentences instructing the generative neural network model to propose modifications to the path data reflecting the monitored progress.

17. The system according to claim 16, wherein the circuitry is configured to adjust the threshold based on a time elapsed since generation of the path data, such that the threshold decreases as elapsed time increases, thereby increasing the frequency of path updates for users with low progress rates over time.

18. A system comprising:
circuitry configured to:
receive, via a communication interface coupled to a packet-switched network, natural language input data from a terminal device operated by a user;
apply tokenization and sentence boundary detection to the natural language input data to produce structured text data, generate structured prompt sentences encoding the structured text data with task-specific instruction prefixes, and obtain structured objective data comprising a user objective, associated skill categories, and a proficiency level from responses of a transformer-based generative neural network model;
normalize the structured objective data by mapping a target field to a standardized category and a skill indicator to a standardized skill category from a classification data set, and store user profile data in a storage device;
search a content data set for content candidates matching the standardized category and the standardized skill category, generate further prompt sentences encoding content candidate metadata and the user profile data, and obtain a ranked list of content identifiers with ordering information from the generative neural network model, and assemble the ranked list into path data;
transmit the path data to the terminal device via the communication interface; and
receive progress event data comprising at least one of viewing, start, completion, or evaluation events, generate update prompt sentences combining the progress event data and the user profile data, and dynamically update the path data based on proposal data from the generative neural network model.

19. The system according to claim 18, wherein the circuitry is configured to estimate an emotional state of the user from text data or voice data received from the terminal device, classify the emotional state into an emotional category, and select a prompt sentence template based on the classified emotional category to adjust a guidance level and detail level of responses generated by the transformer-based generative neural network model.

20. A method comprising:
receiving, via a communication interface coupled to a packet-switched network, natural language input data from a terminal device operated by a user;
converting the natural language input data into structured text data, generating structured prompt sentences from the structured text data, and obtaining structured objective data comprising at least a user objective and associated skill categories from responses of a generative neural network model;
normalizing the structured objective data by selecting at least one standardized category and at least one standardized skill category from a classification data set stored in a storage device, and storing resulting user profile data in the storage device;
searching a content data set for content candidates based on the user profile data, generating further prompt sentences from metadata of the content candidates, obtaining selection and ordering information from the generative neural network model, and generating path data for the user based on the selection and ordering information;
transmitting the path data to the terminal device via the communication interface; and
receiving progress event data from the terminal device, generating update prompt sentences from the progress event data and the user profile data, and dynamically updating the path data based on proposal data obtained from responses of the generative neural network model.
